(19) United States
(12) Patent Application Publication
(10) Pub. No.: US 2019/0269999 A1
(43) Pub. Date: Sep. 5, 2019

(54) SYSTEMS AND METHODS FOR PROJECTION OF ONE OR MORE SAFE VISIBLE LASER LINES FOR DELINEATION IN VARIABLE AMBIENT LIGHTING

(71) Applicant: Alan Barry Amron, Riga (LV)

(72) Inventor: Alan Barry Amron, Riga (LV)

(73) Assignee: John A. Anderson, Coquitlam (CA)

(21) Appl. No.: 16/192,721

(22) Filed: Nov. 15, 2018

Related U.S. Application Data
(60) Provisional application No. 62/590,365, filed on Nov. 24, 2017.

(51) Int. Cl. A63C 19/06; H05B 37/02; A63B 71/06

(52) U.S. Cl. CPC A63C 19/065; H05B 37/0218; H05B 37/0227; A63C 2203/14; A63B 2220/805; A63B 2071/0694; A63B 2243/007; A63B 71/0622

(57) ABSTRACT

A temporary or permanent safe line projection system comprises a stationary or movable structure that is dimensioned and arranged to be supported by and project upwardly from an athletic field surface (or other surfaces needing delineation). A laser source is supported by the movable or stationary structure and is maintained by the movable or stationary structure at an elevated location relative to the athletic field surface (or other surface needing delineation). This allows the laser source to direct safe optical energy downward upon the field while the movable or stationary structure is maintained substantially in a first orientation relative to the athletic field surface (or other surfaces desiring delineation). A sensing arrangement is operative to to disable the laser source or modulate its output depending upon proximity of users to the system or its output and upon ambient lighting conditions, as the case may be.

### REFERENCE TO RELATED APPLICATIONS

This application claims the benefit priority of U.S. Patent Application Ser. No. 62/590,365 filed by Amron on Nov. 24, 2017 and entitled “Systems and Methods for Projection of one or more safe visible Laser lines for Delineation in variable ambient lighting” the disclosure of which is expressly incorporated herein by reference in its entirety.

### BACKGROUND OF THE INVENTION

### Field of the Invention

The present invention relates generally to the safe projection of visible lines and other useful but temporary markings onto a surface and, more particularly, to safe systems employing one or more lasers to project such markings upon a surface for delineation.

### Description of the Related Art

A number of popular and widely televised outdoor sporting and athletic events rely upon boundary markings and/or measurements by which to measure the performance of one competitor or team against the competition. Examples of the former include tennis and soccer, which are both played outdoors—often during the daytime in conditions which can vary from brightly lit to overcast. Examples of the latter include many track and field events familiar to spectators of the Summer Olympics. By way of illustration, distance measurements are utilized in such events as the shot put, the discus and javelin throws, and even the long and broad jumps. After each athlete performs, the applicable distance is measured and recorded for later comparison to the athlete's own prior performances, the performances of the other athletes, and even to the current world record for the event.

Distance measurements are also critical to the conduct of the game of football. In football, a key objective of the team in possession of the ball (i.e., the “offense”) is to retain possession of that ball by moving it far enough down the field. Specifically, the offense is given a set of four plays or “downs” to advance the ball by at least ten yards. Each time that distance is reached or exceeded, the offense is said to have crossed a “first down” line, a new set of downs is earned, and the offense is allowed to continue its advance toward the goal line of the opposing team (i.e., the “defense”). If the offense falls short, however, possession is lost and the two teams reverse their roles. A regulation football field has a length of 100 yards and 53 yards. Thus, by way of example, a team gaining possession of the ball at its own 20 yard line must move the ball a total of eighty yards in order to reach the end zone of the opposing team.

In numerous occasions throughout an average football game, the officials of the game must resort to sideline markers to establish whether the offense has advanced the ball by the required distance. The standard alignment system that is utilized is generally a pair of poles connected by a 30 foot long chain. The relative position of the football is measured by locating a first of these poles at the approximate location of the initial line of scrimmage and moving the second as far forward as possible. Each time this measurement is made, the game must be delayed and the yard markers must be carried from the sidelines to the place on the field where the official has “spotted” the ball. Although the game of football has become a relatively complex sport, involving literally hundreds of millions of invested dollars, this time consuming system has remained relatively the same since the conception of the sport.

Television networks have recently implemented an image pre-processing system which allows viewers of televised football games to see a so-called “virtual” first down line that digitally projects, in real time, a visible line onto video frames recorded by the television camera, the line being displayed on a viewer's television set so that it appears to extend between the first down sideline markers. Unfortunately, neither the players, game officials, nor the fans attending such games can actually see this virtual line. Similar virtual markings have been used to show television viewers whether a tennis ball landed in the service box or within the court boundaries and as an aid to the official review process for that sport. It is evident that virtual projection systems do nothing to enhance the experience of the spectators who actually attend the events. Indeed, the lack of a real-world equivalent may very well detract from the experience of those fans who are accustomed to seeing these markings on television.

The inventor herein has previously proposed several different systems and methods for projecting a visible reference light onto an athletic field. ALL OF THEM HAVE NOT INCLUDED A SAFE PROJECTION OF A LASER LINE SYSTEM AS DESRIBED HEREIN.

### SUMMARY OF THE INVENTION

The aforementioned temporary or stationary marker projection systems is suited for use under controllable or static (substantially unvarying) ambient lighting conditions. However, the inventor herein has observed that an unmet need exists for systems which are capable of projecting a temporary or permanent marker bright enough and/or wide enough to be seen from different perspectives and, optionally, from considerable distances for safety concerns.

The inventor herein has also observed a need for systems capable of projecting a line segment, boundary line, spot, or other marking which, though intense enough to be seen from a wide range of viewing angles, conforms to all applicable eye-safety regulations such as those promulgated by the FDA's Center for Diagnostic and Radiological Health (CDRH).

### DETAILED DESCRIPTION OF EMBODIEMENTS

Embodiments consistent with the present disclosure are directed to systems which are capable of projecting and/or utilizing one or more markers that remain visible under ambient lighting conditions which may vary substantially over an applicable interval of time. Such lighting conditions may be encountered, for example, at an outdoor athletic or sporting event, a construction or mining worksite, or at locations where traffic (e.g. vehicular or aviation) is being directed or guided to maintain public safety,

In some embodiments, a laser projecting apparatus is selectively movable along the side of, and/or above, a target surface and is dimensioned and arranged to project at least one temporary, visible reference line upon the target surface. The target surface may include a portion of an athletic field, a race track, the ground and/or road surface of an activity site (e.g., a construction or mining site), a road or airfield traffic control area, or a manufacturing or warehouse facility whose efficiency would be enhanced by the availability of one or more reference marking(s) to guide workers to and from inventory location and/or to delineate other boundaries or locations in the course of a workflow process.

In an embodiment, a system consistent with the present disclosure comprises a movable structure that is dimensioned and arranged to be supported by and project upwardly from an underlying surface. The system further includes a laser source supported by the movable structure, the laser source being maintained by the movable structure at an elevated location relative to a target surface. This allows the laser source to direct optical energy downward upon the target surface while the movable structure is maintained substantially in a first orientation relative to the underlying surface. A safety system includes a position sensing arrangement operative to determine when one or more persons is too close to the system itself or to the optical energy output by the system. Systems consistent with the present disclosure may further include one or more proximity sensors and an image capture device and image analysis system adapted to monitor the relative position of moving objects on a surface relative to the output of the system. The laser source may consist of a laser, power source, and associated optical output shaping elements as, for example a laser projector unit, with at least the projector unit being supported by and movable as a unitary whole with the movable structure. In an embodiment, the output of the laser source is further responsive to an ambient light intensity measurement and analysis subsystem, the output of the laser source being either disabled or modulated in the interest of safety and power efficiency according, for example, to an empirically derived performance curve.

In some embodiments, an apparatus provides at least one visible marker (e.g., an arrangement of guiding lines or line segments) for the duration of a site activity period, wherein the projected visible is usable as a reference aid throughout the site activity period despite dynamically variable ambient lighting conditions. In an embodiment, a system includes at least one laser source operative to direct optical energy at a wavelength of between 380 nm and 750 nm upon a surface proximate a first site location and an ambient light sensor dimensioned and arranged to detect variations in an intensity of sunlight at the first site location so as to approximate an intensity of sunlight striking the surface. Each laser source includes one or more lasers operated a power level of 10 to 100W each, and either in tandem such that their output is combined or in a prescribed sequence, so that less than all of a plurality of lasers (i.e., a subset) are operated at any given interval within the site activity period.

In some embodiments, a computer, which includes a processor and a memory, is operatively associated with the ambient light sensor, the processor being operative to execute instructions stored in memory to select, responsive to detected changes in ambient light intensity, any of a same, decreased and increased laser power output in order to continuously maintain visibility of a projected line for the duration of the site activity period. A laser controller is operatively associated with the at least one laser and, according to embodiments of the invention, is communicatively coupled to the computer. The laser source controller is operative to modulate an output of the at least one laser source responsive to commands from the computer to any of maintain, decrease or increase an output of the at least one laser source.

In an embodiment, a computer implemented method for continuously projecting a reference aid over the course of an activity period comprises receiving, at a computer controlled laser projection system, a request to project at least one line extending from a first site location, over a site activity period, as a reference aid for use in at least one of approaching and departing the first site location. The method further comprises detecting variations in ambient light intensity during the site activity period, and operating at least one laser source of the laser projection system, responsive to the detecting, to project a lane which is visible continuously throughout the site activity period. In an embodiment, a site activity period is at least 24 hours and the operating is performed continuously over the site activity period and under ambient operating conditions ranging from full daylight to artificial light only. Disruption of operation occurs only if a manual override is actuated, or an unsafe condition such as a dangerous level of explosive vapor in the atmosphere or a level of vibration indicative of an explosion or other even disruptive to continued processing operations at the site location. While a system consistent with the present disclosure is in use, vehicles and equipment are operated by reference to the projected line to situate them at a desired location relative to a work site processing facility or other work site location.

In yet another embodiment, a system consistent with the present disclosure includes a camera and an image analysis algorithm stored in memory and executable by a processor of a computer to determine the information of a still or moving object (not limited to) then based on calculation's or typed in instructions sent to a laser line projecting apparatus, mounted to a guy wire delivery system, that is selectively movable along and above the center of a playing field, and or stadium, and dimensioned and arranged to project at least one fixed and or temporary, visible reference first down laser line or a touch down laser line onto a playing surface. A camera and or a learning programmed computer system or a switching remote controlled wireless device, constructed in accordance with the teachings of the present invention comprises a movable laser source and projector system on a guy wire structure that is dimensioned and arranged to be supported by and project onto a target on the field of play. The system can further include a remotely located larger laser source (not limited to) connected via fiber optic cable (or the actual larger laser source itself) to a mounted on a guy wire system moveable up and down the field which is supported by the movable structure, the laser source being maintained remotely (or mounted on the guy wire system itself) in another loaction and the laser line projector moves by the movable structure (or mounted in one or more different locations) at an elevated location relative to the target playing field surface. This allows the camera's view and laser projected source to direct optical energy (not limited to) directly downward upon the field or stadium while the movable structure (or still mounted) is maintained substantially in a first orientation relative to the target playing surface. The learning algorithum anticipates the movements of objects and things on the field in the stadium to determine the location of the projected first down or touch down laser line, (not limited to) to display a specific laser line across the field directly from overhead to show the players, officials, coaches, fans in the stands and on all the cameras different angles broadcasting the event where the usually invisible first down line really is.

In a further embodiment, a system adapted for use in associate with objects movable on a target surface in a cyclical fashion (e.g. cars or runners racing in laps around a track) comprises a camera and algorithm determining the information of a still or moving object (not limited to) then based on calculation's sent to a laser projecting apparatus that is selectively movable along a field and or stadium and dimensioned and arranged to project at least one temporary, visible reference graphic onto a surface. A camera and learning programmed system constructed in accordance with the teachings of the present invention comprises a movable structure that is dimensioned and arranged to be supported by and project onto a target surface. The system further includes a laser projected source (not limited to) supported by the movable structure, the laser source being maintained by the movable structure (or mounted in one or more different locations) at an elevated location relative to the target surface. This allows the camera's view and laser projected source to direct optical energy (not limited to) downward upon the field or stadium while the movable structure (or still mounted) is maintained substantially in a first orientation relative to the target surface. The learning algorithm anticipates the movements of objects and things on the field in the stadium or on a track, to determine their location and amount of revolutions and or trips around the track in relation to the laser graphic, (not United to) to display a specific corresponding graphic (numbers, but not limited to) determined.

Examples include the number of revolutions, elapsed time from beginning the race, and/or a difference in pace between a given athlete and a leading athlete or applicable record (e.g., world record, event record, etc).

In yet a further embodiment consistent with the present disclosure, a helmet head directional camera and learning programmed system comprises a movable structure that is dimensioned and arranged to be supported by and project onto an athletic field surface. A camera and an algorithm executable by a processor of a computer which performs image analysis to determine helmet orientation and/or an algorithm executable by the processor of a computer to determine helmet orientation by analyzing accelerometer or other sensory input mounted on the helmet, controls switching on or off a laser projecting apparatus that is selectively movable along a first sideline of an athletic field and dimensioned and arranged to project at least one temporary, visible reference line across the athletic field surface. The system further includes a laser projected source supported by the movable structure, the laser source being maintained by the movable structure at an elevated location relative to the athletic field surface. This allows the camera's view and laser projected source to direct optical energy downward upon the field while the movable structure is maintained substantially in a first orientation relative to the athletic field surface. The learning algorithum anticipates the helmet and head directional movements of players and officials on the field of play, to determine their location in relation to the laser line, to shut off in case of caution preset zone and preset frames are determined.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a block diagram depicting the various functional elements of an exemplary temporary marker projecting system according to an embodiment of the invention.

FIG. 2 is a block diagram depicting the various functional components of the position analysis subsystem utilized in the construction of the illustrative temporary marker projecting system of FIG. 1;

FIG. 3 is a block diagram depicting the various functional components of the light intensity analysis subsystem utilized in the construction of the illustrative temporary marker projecting system of FIG. 1;

FIG. 4A is a side elevation view illustrating, in a stowed position, a portable embodiment of a temporary marker projecting system constructed in accordance with the teachings of the present invention;

FIG. 4B is a side elevation view depicting the embodiment of FIG. 2A, deployed in a position of maximum extension for use in projecting one or more temporary markers in accordance with the teachings of the present invention;

FIG. 5 is a partial side elevation view of a non-transportable embodiment of a temporary line projecting system, the system being dimensioned and arranged for telescoping extension from a retracted position underground to a deployed, above-ground position;

FIG. 6A is a perspective view of a portable embodiment of a temporary line projecting system for use in connection with the game of football;

FIG. 6B depicts the projection of a single, static reference marker for use during the game of football by operating a system such as the one exemplified by FIGS. 1-3 and 6A;

FIG. 7A depicts the projection of one or multiple, static reference markers simultaneously in accordance with a novel method of operating a temporary marker projecting system such as one of the exemplary systems illustrated by FIGS. 1-5;

FIG. 7B depicts the projection of at least one dynamically updated, rate-based marker in accordance with another novel method of operating a temporary marker projection such as one of the exemplary systems illustrated by FIGS. 1-5;

FIG. 8A is a flowchart depicting a process for operating a temporary marker projecting system so as to obtain temporary, static or dynamic markers such as the ones shown in FIGS. 7A and 7B;

FIG. 8B—are respective views showing an arrangement of line segments projected upon exemplary target surfaces according to one or more embodiments;

FIG. 9A is a block diagram depicting the various functional elements of an embodiment of a reference aid projecting system deployed at an exemplary activity site which includes three site locations.

FIG. 9B is a block diagram depicting the various functional components of the reference aid projecting system of FIG. 1;

FIG. 10A is a block diagram depicting the deployment of a reference aid projecting system at a processing station of a mining site, according to an embodiment;

FIG. 10B is a block diagram depicting the construction of an exemplary laser projector as part of a laser projection system in accordance with embodiments;

FIG. 11 is a flow chart depicting steps of operating embodiments of a laser projecting system to provide a continuous reference;

FIG. 12 is a flow chart depicting, in greater detail, a series of steps which may be performed as part of the exemplary process of FIG. 5 according to some embodiments;

FIG. 13 is a flow chart depicting, in greater detail, a series of steps which may be performed as part of the exemplary process of FIG. 5 according to some embodiments; and

FIG. 14 is a flow chart depicting, in greater detail, supplemental steps which may be carried out as part of the illustrative process of FIG. 5 according to some embodiments;

FIG. 15 depicts projection of a visible first down line onto a target surface by an overhead laser projecting apparatus suspended and moved by wires according to one or more embodiments, the projecting apparatus receiving optical energy from one or more laser source(s) by via one or more optical waveguides (e.g., optical fibers) and being movable into a location suited for projecton of a reference line onto a target surface (e.g., at the exact overhead location pointed direcly down required by the official location of the first down marker on a playing field);

FIG. 16 depicts operaton of a system according to an embodiment of the invention projecting a fiber optic fed (or no fiber optic used if the laser source is on board the moveable guy wire delivery system itself) up and down the field remotely controlled by computer moveable guy wire delivery system, first down laser line pointed onto an exact mark on the playing field. Either determined by the referee and or by the operator;

FIG. 17 is an example of system according to an embodiment of the invention travel delivery system mounted to both ends of the stadium over head so as to deliver a projected first down laser line onto the playing field for all to visibly see and use during a game;

FIG. 18 is an example of a location for a suggested embodiement of a referee held controller for the laser source controlled by our computer program and fiber optic fed or not fiber optic fed using the actual laser source on board the delivery system itself, moveable up and down the length of playing field laser projector system according to an embodiment of the invention;

FIG. 19 is an overhead view of a predetermined projected on to the playing field for everyone in the stadium and on the TV broadcast to visiably use as a first down line and or a touch down line use reference and or to alert of a first down and or a touch down;

FIG. 20 are examples views of detection systems on to the playing field for our first down laser line breaking notice, touch down goal laser line alerts with knee down first or not system and example of above the goal posts laser lines detection alerts;

FIG. 21 is an example of graphics projected on many objects according to an embodiment of the displaying a graphic on the tops of all objects on the filed stadium and or track.

FIG. 22 is an example of system according to an embodiment of the invention projecting on the tops of each object car to display position in the race;

FIG. 23 is an example of system according to an embodiment of the invention projecting on the tops of each object car to display position in the race;

FIG. 24 is an example of a location for a laser source controlled by our program and projector system according to an embodiment of the invention;

FIG. 25 is an overhead view of a predetermined preset graphic projected on to the objects (cars) to explain position numbers in the race for each car at that particular moment in the race for fans and everyone in the stadium to visible see. camera monitors and anticipates directional movements of the cars (objects, things and or people) frame by frame;

FIG. 26 is an example car in position 1 winning the race, movements off the laser graphic based on predetermined programmed learned amount of laps accomplished without fouls, number of pit stops made etc;

FIG. 27 is an example cars in position 3 and 4 in the race, movements off the laser graphic based on a manually programmed or learned amount of laps accomplished without fouls, number of pit stops made etc;

FIG. 28 is an example of camera frames and looking striaght positions system according to an embodiment for switching on or off a line projected on the ground;

FIG. 29 is an example of frames and looking right positions system according to an embodiment of the invention switching the line on ground off;

FIG. 30 is an example of frames and looking striaght positions system according to an embodiment of the invention switching the line on ground on;

FIG. 31 is an example of frames and looking left positions system according to an embodiment of the invention shutting the line on ground off;

FIG. 32 is an overhead view of a predetermined preset caution zone that the camera monitors and anticipates directional movements of the helmets and heads frame by frame; and

FIG. 33 is an example of frames of helmet and head movements to turn on and off the laser line based on predetermined programmed learned safety angles.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “laser source” is intended to refer both to arrangements in which a coherent laser beam source and beam projecting optics are integrated into a single housing at a common mounting location and to arrangements in which the laser source itself consists of optical beam collimating, diffusing and/or scanning elements configured to receive, via a waveguide (e.g., optical fiber), the output of a remotely located laser source. The term “laser sources” should also be understood to encompass other line forming arrangements besides those which rely upon beam diffusing elements such as lenses, including for example, the movement of mirrors to implement a “scanning” operation.

It should also be understood that although the exemplary embodiments illustrated and described herein relate specifically to the projection of a visible straight line onto the grass surface of a football field, the teachings of the present invention are equally applicable to the projection of other types of lines—including images, logos, advertising messages, and the like—onto any surface covered by real or artificial turf.

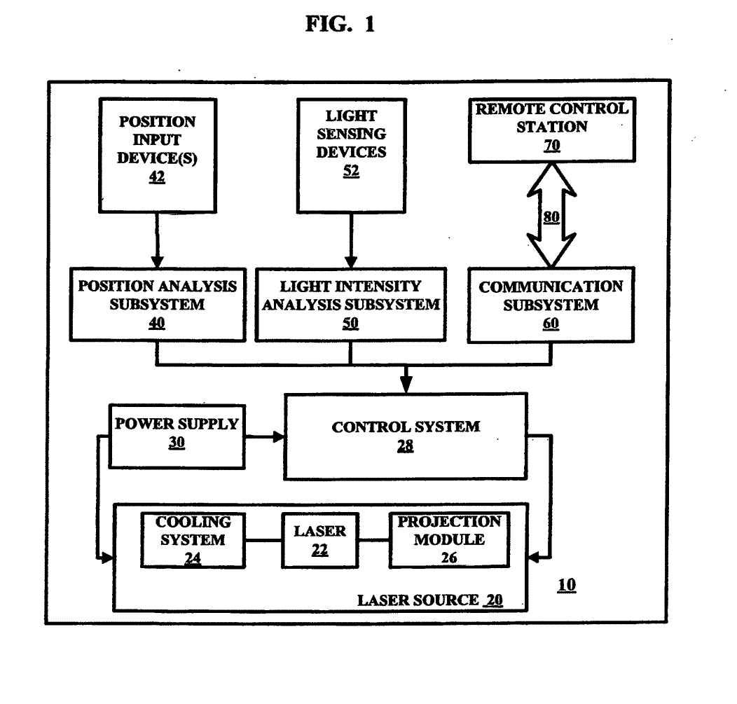

With initial reference to FIG. 1, there is shown a block schematic diagram depicting a temporary marker projecting system 10 in accordance with an illustrative embodiment of the invention. System 10 includes a laser source indicated generally at 20, which includes a laser 22 and a cooling system 24 for maintaining the laser within a temperature range suitable for safe operation. Laser source 20 further includes projection module 26 adapted to receive the optical energy from laser 22 and, responsive to control signals received from control system 28, direct the optical energy onto an athletic field or other surface (not shown). Power for laser source 20 and control system 28 is provided by a power source indicated generally at 30.

In accordance with an illustrative embodiment of the invention which will be described later, laser 22, cooling system 24, and projection module 26 are all supported by a transportable platform structure for collective positioning in proximity to the surface upon which one or more visible markers are to be temporarily projected. In accordance with an alternate embodiment which will also be described later, projection module 26 is mounted on a telescoping structure which is extensible between an in-ground retracted position and an extended, above ground position. In both of the illustrative embodiments, power and optical energy output by laser 22 are generated remotely relative to projector module 26 such that these are supplied via an electrical cable and an optical fiber, respectively. It should be emphasized, however, that the aspects of the present invention relating to safe operation and adaptability to dynamically varying ambient lighting conditions are equally applicable to alternative configurations and that the particular projecting platforms described herein are for exemplary purposes only.

With continuing reference to FIG. 1, it will be seen that system 10 further includes a position analysis subsystem 40, a light intensity analysis subsystem 50, and a communication subsystem 60. Each of the aforementioned subsystems is communicatively coupled to control system 28 which, in turn, is configured to disable the output of laser source 20 or to vary that output responsively to input from those subsystems. Control system 28 is responsive to input from position analysis subsystem 40, for example, to immediately disable the output of laser source 20 when one or more persons gets too close to system 10 itself or to the optical energy output by system 10. Likewise, control system 28 is responsive to input from light intensity analysis subsystem 50 to immediately disable the output of laser source 20 when a reduction in the intensity of ambient light is so rapid as to cause the pupil of the average human eye to dilate sufficiently to expose that eye to levels of visible laser radiation in excess of the accessible emission limits contained in Table II of 21 CFR Subchapter J Part 1040.10 (i.e., above the threshold for Class IIIa mode of operation under rules promulgated by the U.S. Center for Devices and Radiological Health.

In accordance with an especially preferred embodiment of the present invention, control system 28 is further responsive to input from light intensity analysis subsystem 50 to dynamically vary the output of laser source 20 in response to changes in the intensity of ambient light which are noticeable to the human observer. For example, on a partly cloudy day, it is possible for ambient lighting conditions to vary considerably from one moment to the next. During periods when the level of ambient light is at its peak, say above a level of hi noon sun light, it is necessary to safely operate the laser source (in multiple different angled projectors to decrease the possible exposure at any one given projection point but to give the overall line full brightness and power) at its highest power rating (e.g., 200-300 W). Conversely, as a cloud is passing over, the unnecessarily high brightness of a temporary marker projected by system 10 may become a distraction to observers and event competitors alike. Reductions in the output power of laser source 20 are not only warranted during such periods, but they also serve the interests of maintaining Class Ma operation as noted above and also power conservation.

Data for operation of position analysis subsystem 40 of system 10 is collected from position input devices indicated generally at reference numeral 42, while data for operation of light intensity analysis subsystem 50 of system 10 is collected from light intensity input devices indicated generally at 52.

Finally, control system 28 is further responsive to instructions manually programmed or input by a remote operator. Such instructions originate at a remote control station indicated generally at 70 and be transmitted, for example, over a conventional communication link indicated generally at 80. In some embodiments, communication link 80 may utilize a communication medium such as an electrical wire or optical fiber and, in others, an over-the-air link may be used. It suffices to say that using such a medium, a remote operator has complete control over the operation of system 10, including the ability to energize and de-energize laser source 20, to set appropriate thresholds of proximity and light intensity levels for subsystems 40 and 50, respectively, and to select the locations and dimensions of the temporary markers to be projected by system 10.

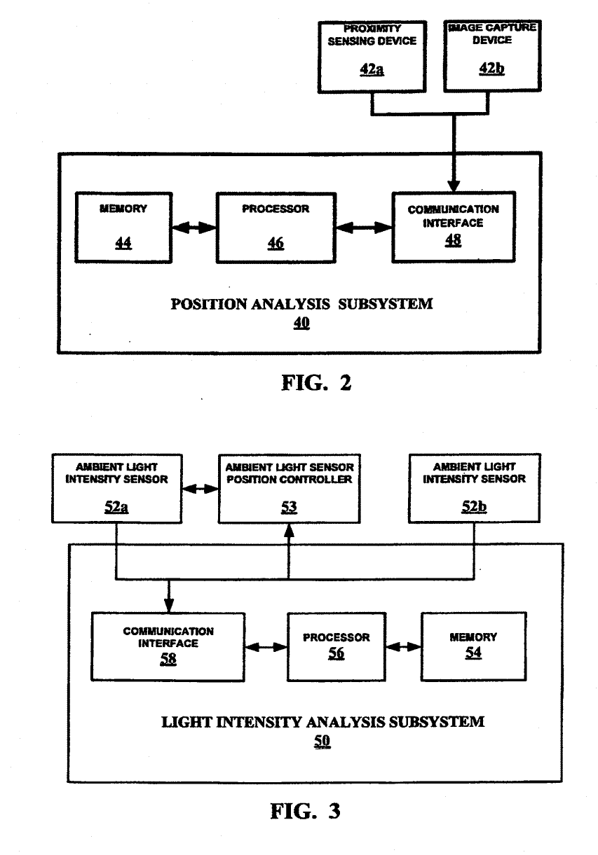

With reference now to FIG. 2, a position analysis subsystem 40 according to the illustrative embodiment of FIG. 1 will now be described in greater detail. As seen in FIG. 1, position analysis subsystem 40 comprises a memory indicated generally at reference numeral 44 and containing instructions executable by processor 46 for performing the position analysis functions of subsystem 44. The output of one or more conventional proximity sensors indicated generally at 42a are provided as input for analysis by processor 46 via communication interface 48. These sensors may be simple motion sensors, infrared (body heat) sensors or some combination of these, and it suffices to say that based on a threshold output value representative of the potential safety hazard to a person coming too close to system 10 during operation thereof, processor 46 determines that control system 28 should terminate the output of laser source 20 as described above.

With continuing reference to FIG. 2, it will be seen that position analysis subsystem 40 may be further configured to gather more detailed data about the movements of persons who, in the absence of suitable precaution, might be injured by the output of laser source 20 (FIG. 1). Specifically, positional analysis subsystem is further programmed with instructions for performing image analysis on the input received from one or more image capture devices (i.e., cameras) indicated generally at reference numeral 42b. An example of a system and algorithm which employs cameras and image analysis executed by a processor such as processor 46 to determine the relative position of moving objects in three dimensional space, which may be readily adapted for systems and methods according to the present invention, is described in published Canadian Patent Application CA2443178 entitled “A MOTION AND POSITION MEASURING DEVICE” and filed on Sep. 23, 2003 by Zhu Li, the disclosure of which is expressly incorporated herein in its entirety.

Through suitable programming, processor 46 executes instructions in accordance with thresholds set by the system operator such that when a person (or human-sized moving object) approaches the surface where a temporary marker is being projected or the path taken by the optical energy used to generate that marker, instructions are transmitted to control system 30 which, in turn, disables laser source 10.

With reference now to FIG. 3, it will be seen that light intensity analysis subsystem 50 of system 10 incorporates many of the same functional building blocks as position analysis subsystem 40. Indeed, at this point, it should be emphasized that the respective subsystems may be implemented either as special purposes devices with their own respective memory, processing and communication interfaces as memory 54, processor 56 and communication interface 58 of FIG. 3, or to make use of a common processor, memory and set of communication interfaces as may, for example, be implemented in the realization of control system 28.

In any event, and with continued reference to FIG. 3, it will be seen that light intensity information is gathered by one or more ambient light intensity sensors indicated generally at reference numeral 52a and 52b. Light intensity sensors as sensor 52a may be dimensioned and arranged to remotely measure ambient light intensity at locations adjacent to the precise region(s) of the surface upon which temporary markers are to be projected by system 10. Light intensity sensors as sensor 52b, on the alternative, may be disposed at respectively discrete, fixed locations individually or collectively representing a reasonable approximation of the ambient light intensity where corresponding temporary markers are to be projected. In a conventional manner, the outputs of intensity measurement sensors 52a and 52b are received as input by processor 46.

Processor 46 may receive additional input from other devices associated with the intensity measurement sensors, such as one or more position controllers respectively associated with a corresponding one of the intensity measurement sensors. A single position controller, indicated generally at reference numeral 53, is shown in operative communication with intensity sensor 52a. Where intensity measurements are taken remotely from locations which are subject to change during an event, it may be necessary to aim an applicable light intensity sensor as sensor 52a at a new location. In the illustrative embodiment of FIG. 3, position controller 53 executes the necessary instructions for moving the light intensity sensor 52a, as necessary, to keep a target measurement collection region, proximate to a projected marker, in proper view.

in embodiments where a single processor is not utilized to perform intensity measurement and analysis and laser source control, processor 46 is communicatively coupled to control system 28. If one or more conditions are met, a processor of control system 28 executes instructions for modulating the output of laser source 20. As mentioned earlier, control system may attenuate the output of laser source 20 so as to produce a lower intensity output, it may increase the output of laser 22 to increase the intensity, or it may disable it altogether. By way of illustration, operation of control system 28 and thus, laser source 20, may be governed by a laser source output power curve derived empirically for the venue, including the viewing angles of spectators, event participants, cameras, and prevailing extremes of ambient light intensity for a given geographic location (e.g., Las Vegas, Nevada vs. Seattle, Washington). Although the development and implementation of one or more such output power curves admits of substantial variation, these tasks are believed to be well within the level of skill of the ordinary artisan and further discussion of such variations is omitted herein for purposes of clarity.

Returning briefly to FIG. 1, communication subsystem 60 is configured to communicate not only with a remote control station via a communication link as noted previously, but also with each of the other subsystems as communication interface 48 of position analysis subsystem 40 and communication interface 58 of light intensity analysis subsystem 50. Of course, where a common processor, memory, and communication interface is used to implement the various functions performed by subsystems 40 and 50 and control system 28 in the above-described embodiment, communication subsystem would interact directly with input devices 42a, 52a and 52b, as well as position controller 53.

The projector module 26 itself may utilize a scanning projector and control arrangement of the type disclosed in U.S. Pat. No. 7,219,438 entitled SYSTEM FOR OPERATING ONE OR MORE SUSPENDED LASER PROJECTORS TO PROJECT A VISIBLE IMAGE ONTO A SURFACE. Closed-loop galvanic scanners (also called “position detecting” scanners), for example, are commonly used in the laser light entertainment industry and are capable of directing a beam to 24,000 to 30,000 discrete points along a selected path every second.

The manner in which the output of laser source 20 is terminated also admits of substantial variation. For example, the laser itself can be de-energized in response to an input received from any one of position sensing system 40, light detection system 50, and a remote control source. Alternatively, projection module 26 may incorporate a conventional shutter mechanism (not shown) such, for example, as an acoustic optical modulator (AOM) for turning off the beam.

For a line width of approximately six inches (15 cm), excellent results have been achieved using a 10 W, frequency doubled, Q-switched Nd:YAG laser adapted to generate laser pulses at a wavelength of 532 nm. Emission at this wavelength is especially preferred since it is very close to the peak (555 nm) of the human eye's sensitivity. By comparison, in an argon ion laser operating in continuous wave (cw) mode, roughly half of the output is at 514 nm (58% as bright as the same beam at 555 nm), another 30% is at around 480 nm (18% as bright) and the remaining 20% is at around 440 nm (barely visible to the human eye). Thus, an argon laser would theoretically have to deliver up to three or four times as much power to match the visibility of the Nd:YAG laser.

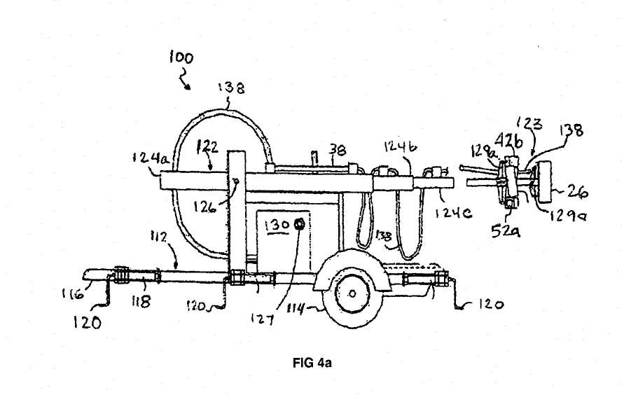

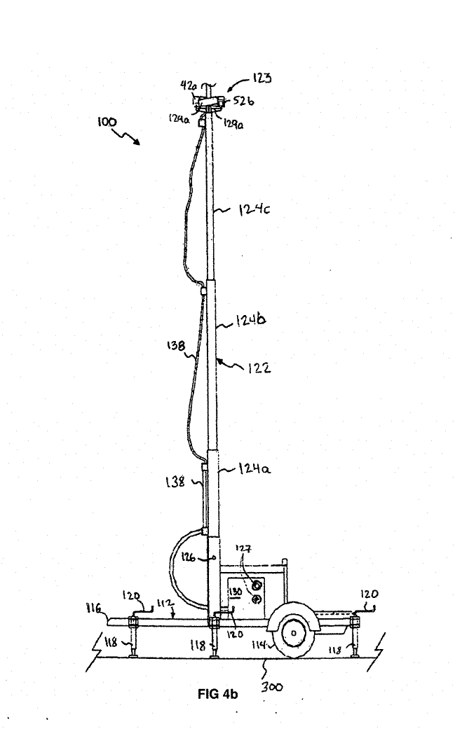

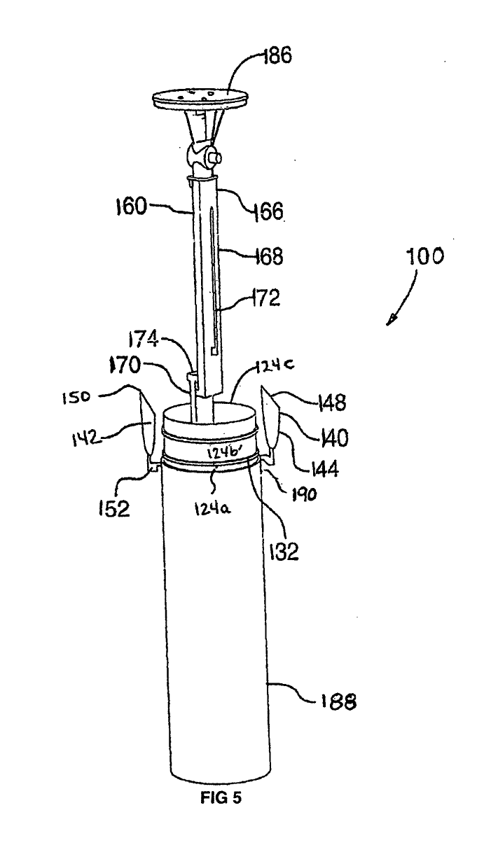

Turning now to FIGS. 4A and 4B, there is a portable embodiment of a temporary marker projecting system 100 constructed in accordance with the teachings of the present invention, with FIG. 4A depicting a folded or “stored” configuration suitable for transport between events or venues and FIG. 4B depicting an extended position wherein projector 26 (FIG. 1) is elevated at a sufficiently high level above the ground surface as to project a visible, temporary marker or graphic display upon a surface where, for example, an event or contest being conducted.

With particular reference to FIG. 4A, it will be seen that system 100 includes a trailer 112 having at least two wheels 114, a tongue 116 for connection to a tow vehicle (not shown), and a plurality of pivotable outriggers 118 to stabilize trailer 112 when the trailer is deployed. Outriggers 118 may be manually pivotable from the generally horizontal stowed position shown to a generally vertical deployed position (FIG. 4B), and each may be retracted and extended to contact the ground by any conventional means, such as a handle 120.

A retractable telescopic mast 122 is mounted to trailer 112. Mast 122 comprises a plurality of extendable sections indicated generally at reference numerals 124a, 124b and 124c, and is pivotable upon a pivot point 126, allowing it to be stowed in a generally horizontal position for storage, movement or transport. A device mounting structure or platform 123 for supporting projection module 26 (FIG. 1) and, optionally, one or more position sensing devices as image capture device 42b (FIG. 2) and one or more ambient light sensing devices as light intensity sensing device 52b (FIG. 3), may be made detachable from mast 124 during transportation and/or storage of portable security system 100 to prevent damage to the respective input devices and projector module due, for example, to excessive shock or moisture intrusion from unusual device attitudes.

Respective one- or two-axis servo mounts 129a provides a remote operator with the ability to bring desired regions of an event surface into the view of a corresponding input device as devices 42b and 52a, and projector module 26. Common controls for image capture device 42b, such as pan, tilt, zooming and focus, may be remotely accessed and adjusted by means of communication link 80 (FIG. 1), as discussed above. The pan and tilt controls are equally applicable to adjustments in the position of projector module 26 and light intensity sensing device 52a, though a separately controlled X-Y scanning head (not shown) may be incorporated into projector module 26 where one or more temporary markers are to be generated using a scanning beam.

A lockable cabinet 130 houses the laser, laser power supply, and laser cooling system. Although an on-board generator can also be incorporated into the design of portable system 100, the illustrative embodiment of FIG. 4A contemplates a power plug receptacle 127 for powering system 100 from a separate source such as a remote generator or AC mains. Likewise, where the laser system is water cooled, cabinet 130 is configured with fluid inlet and outlet ports (not shown) for circulation of the coolant in a conventional manner. Cabinet 130 is preferably made of a sturdy material that is resistant to exposure to the environment and tampering, such as steel, composites and engineered plastics.

A separate cabinet (not shown) receives the afore-described communications, control, position sensing and ambient light sensing systems, and all of these may be powered either by rechargeable batteries or an external electrical source via an external environmentally protected power plug (not shown). The respective cabinets as cabinet 130 may be equipped with a series of locks to prevent theft and tampering. Locks may be used to secure mast 122 and any associated pivoting mechanisms such as a winch, outriggers 118, laser source cabinet 130, and a hitch portion of tongue 116. The locks may be configured such that a single key will unlock each lock. In one embodiment three keys are utilized with portable security system 100. A first key operates the locks. A second key provides access to cabinet 130. A third key is used to control a key-actuated electrical switch to activate portable temporary marker projecting system 100.

FIG. 4B depicts portable temporary marker projector system 100 in a deployed position. As can be seen, outriggers 118 are oriented generally vertically and are in an extended position, engaging the ground 300 to stabilize portable security system 100. Mast 122 is pivoted to a generally vertical orientation and one or more mast sections as sections 124a-124c are extended such that projector module 26 and input devices 42b and 52a are elevated for a clear field of view/projection. Various components of portable security system 100 may be adapted to discourage tampering by unauthorized personnel. For example, exposed cabling (optical and electrical) may be covered with rigid or flexible plastic or metal sheathing 138 (FIGS. 4A and 4B) to prevent disengagement or cutting of the cables. Access points, such as access panels, may be locked using conventional locking devices. Various hardware components may include conventional types of security screws, bolts and nuts, as well as conventional tamperproof fasteners.

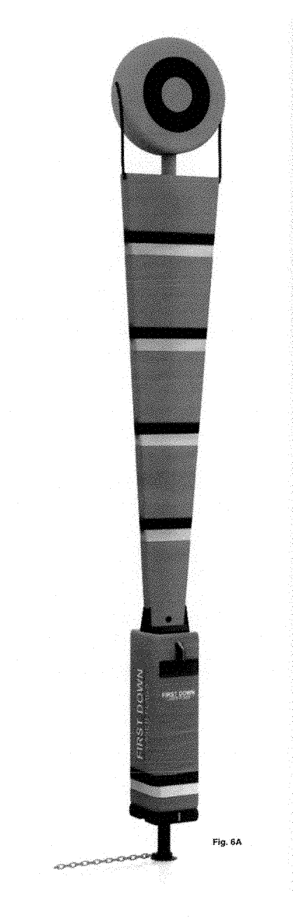

Turning now to FIG. 5, there is shown an in-ground retractable embodiment of a temporary marker projector system constructed in accordance with the teachings of the present invention. Retractable marker projection unit 100′, like the transportable embodiment of FIGS. 4A and 4B, comprises a telescoping support 160 and a platform indicated generally at 186 for supporting the projector module and input devices previously described in connection with FIGS. 1-3, Platform 186 is mounted on a distal portion 166 of telescoping support 160.

In-ground retractable projection unit 100′ further includes a housing 188 comprising a sleeve 190 having a lid 140 hinged to a distal portion of sleeve 190. The lid 140 is movable between a closed position (not shown) and an open position (as shown in FIG. 5). Housing 188 encloses telescoping support 160 and projector/device supporting platform 188 when telescoping support 160 is in the retracted position and when lid 140 is in the closed position. Materials used for constructing housing 188 for retractable projector unit 100′ will depend on the environment in which the unit will be deployed. As the retractable projector unit 100′ may be substantially installed in ground, housing 188 is preferably water resistant and/or dust resistant. Typically, housing 188 is constructed using a water and dust resistant plastic. To enhance dust resistance, weather resistant housing 188 may be in the form of a cylindrical sleeve 190.

Housing 188 comprises a plurality of telescoping sleeves as sleeves 124a′, 124b′ and 124c′. Sleeve 124c′ nests within sleeve 124b′ which, in turn, nests within sleeve 124a′. Sleeves 124b′ and 124c′ may be moved relative to sleeve 124a′ between a retracted position wherein the former sleeves are nested within sleeve 124a′ and an extended position wherein they are at least partially extended beyond sleeve 124a′, thereby bring the projector module 26 (FIG. 1) and any input devices supported by platform 186 to a desired elevation above the surface of the ground.

With continued reference to FIG, 5, it will be seen that telescoping support 160 comprises a pair of arms 168, 170 capable of extending longitudinally relative to each other. Each arm 168, 170 defines a guide slot 172 along which the other arm 168, 170 is slidably movable. Each arm 168, 170 further comprise a stop 174 to prevent the detachment of the arms 168, 170 from one another.

An actuating system (not shown) is provided for moving telescoping support 160 upward relative to housing 188, between a retracted position, wherein telescoping support 160 is contained within the housing and an extended position, wherein a portion of the telescoping support 160 is extended outside of the housing 188. In alternate embodiments, an actuating may also be used for telescoping sleeves 124a′-124c′ of housing 188 upward relative to sleeve housing 188, between a retracted position wherein the nested sleeves are contained within the housing and an extended position wherein a portion of at least one of the sleeves is extended outside of housing 188. By way of illustrative example, the actuating system may be configured as piston 80, such as a dual or triple stage piston capable of moving the telescoping support and sleeves independently. Alternatively, the actuating system may be a screw jack-based system comprising a screw, a motor assembly for rotating the screw, and a plurality of nuts, each mounted on an extendible portion of the telescoping support 160, wherein each nut departs the screw when the extendible portion on which it is mounted reaches a limit of extension.

At least one seal 132 is disposed around a distal end of sleeve 124a′. Seal 132 preferably has a downwardly tapered profile to facilitate the ejection of any foreign matter present on the housing. Upon elevation of the housing 188, any accumulated foreign matter such as dirt and dust will be transported down and away from the housing. Housing 188 further comprises a lid 140 hinged to a distal portion of sleeve 190. Lid 140 preferably comprises first 142 and second portions 144 with each of the portions being opposably hinged to a distal portion of housing 188 which extends above the ground level when the retractable projector unit 100′ is in use. Preferably, self-clearing/non-jamming hinges 152 are employed to attach the lid 140 to the housing 188.

Lid 140 is movable between a closed position (not shown) and an open position (as shown in FIG. 5). The first portion 142 and second portion 144 of lid 140 are configured to move outwardly in opposing directions to actuate the lid 140 to the open position. Each of the first and second portions 142, 144 are sized to cover the opening of the housing 188 when the lid 140 is in the closed position. To that end, first and second portions 142, 144 of the lid 140 are sized and configured such that they lay substantially flat with opposing edges 148, 150 of the first and second portions 142, 144 abutting one another. Opening and closing of the lid 140 may be coordinated with the extension of the telescoping support 160 wherein extension of the telescoping support 160 causes each of the first and second portions 142, 144 to be displaced outwardly to either side of the housing 188. Retraction of the telescoping support 160 causes each of the first and second portions 142, 144 to return the closed position. Alternatively, the lid 140 may include an independent actuating system, such as for example, remotely controlled motorized hinges, for moving the lid 140 between the open and closed position.

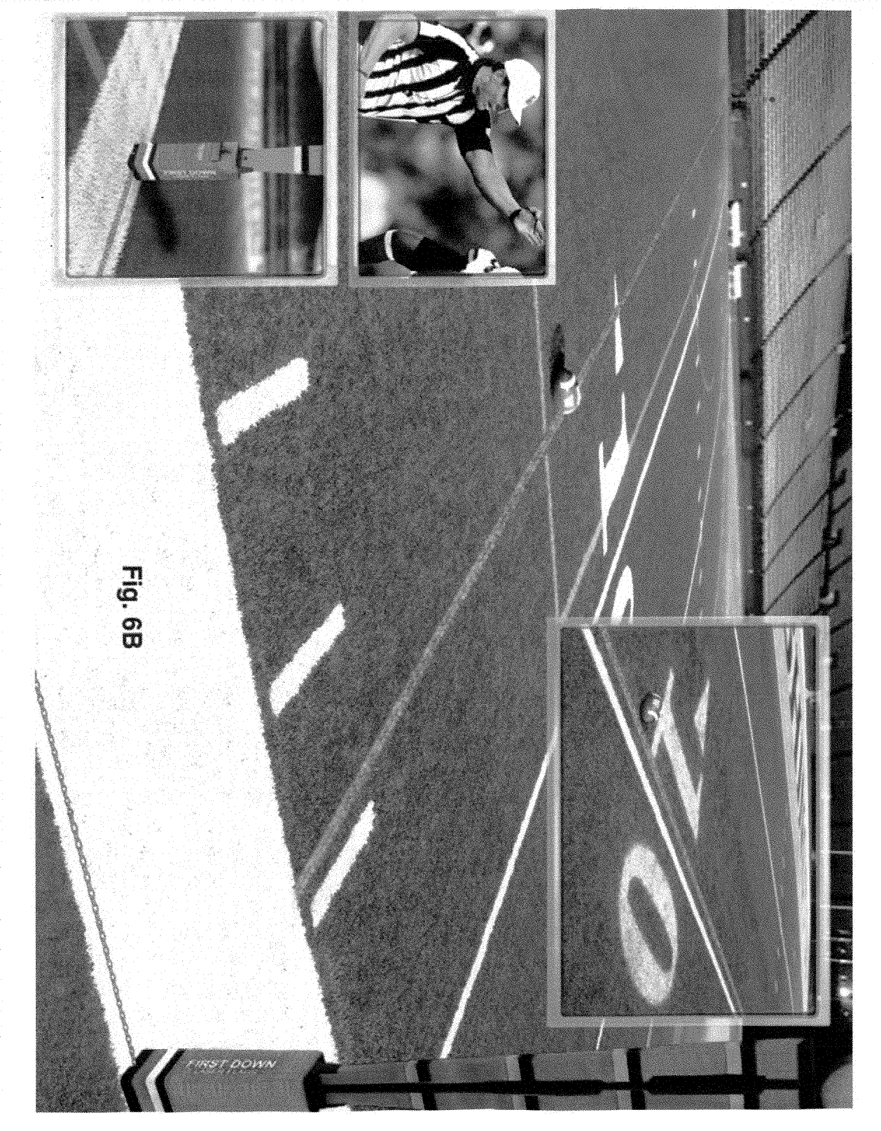

It will, of course, be readily appreciated by those skilled in the art that a variety of other projection module mounting configurations are possible besides those exemplified by FIGS. 4A, 4B and 5. By way of illustrative example, there is shown in FIG. 6A an alternate configuration for use during a game of football. Laser projector module 26′ is secured to a hand-graspable first pole 160′ for selective placement, for example, by a member of a league's or athletic conference's officiating staff. In the same manner as conventional poles and chains are used today, first pole 160′ is adapted for manual positioning and movement relative to a second pole (not shown) to which it is chained. In use, the second pole is placed along the initial line of scrimmage for a set of downs. A laser, power supply, cooling system and control system (none of which are shown) is preferably located in an underground vault at a convenient location within proximity to one of the sidelines. Ports (not shown) for detachable power, cooling and optical connection to laser projector 26′ are disposed at a plurality of convenient locations along one or both of the lateral sidelines of the field. In use, first pole 160′ is moved until the chain connecting it to the second pole is taught, and the laser projector module 26′ is activated, subject to dynamic modulation or teiinination of the laser output according to the operation of a control system as previously described in connection with FIGS, 1-3.

In a modified configuration, second pole is omitted and pole 160′ is maintained at a fixed “first down” position for a complete set of downs, and the system is continuously operated for that set of downs, again in accordance with the operation of a control system—including position analysis and light intensity analysis subsystems and corresponding input sensor elements dimensioned and arranged as necessary to provide the necessary control inputs—as exemplified by the embodiment depicted in FIGS. 1-3. In FIG, 6B, there is shown a temporary visible line L onto football field surface S.

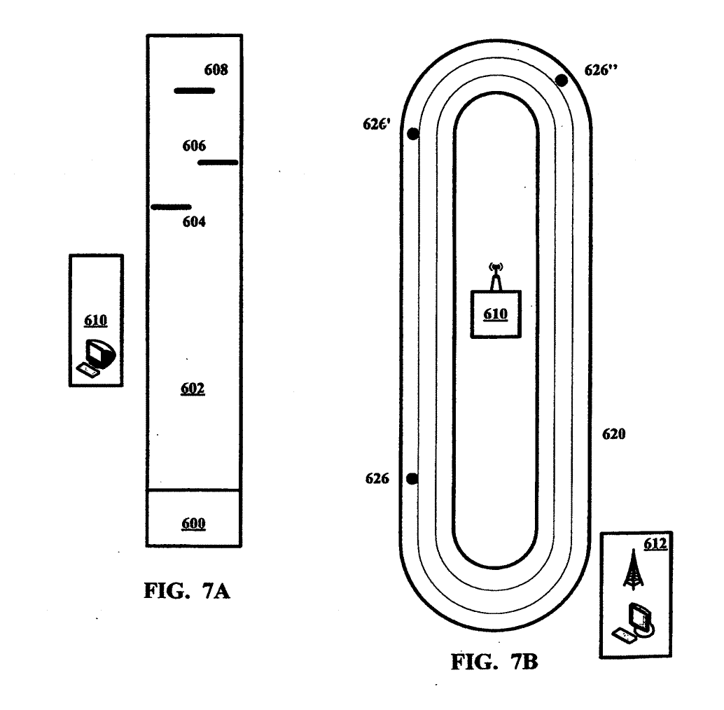

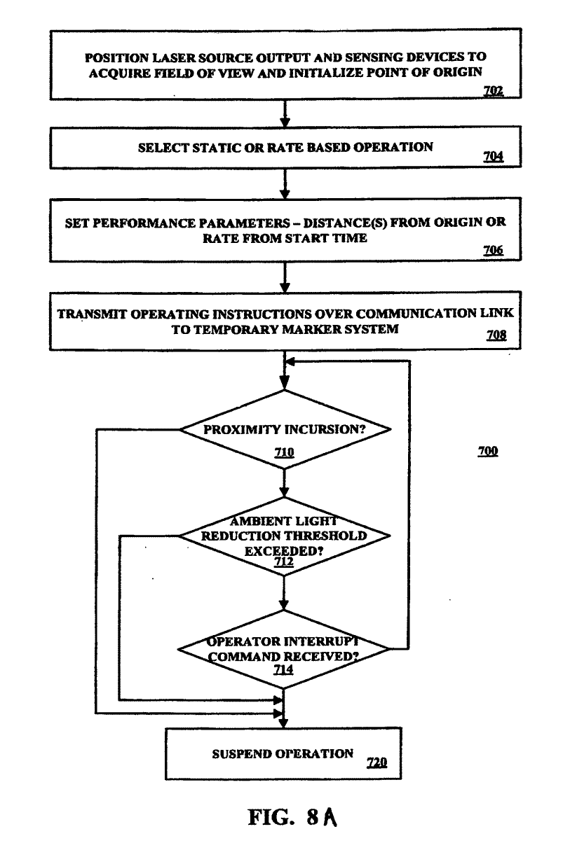

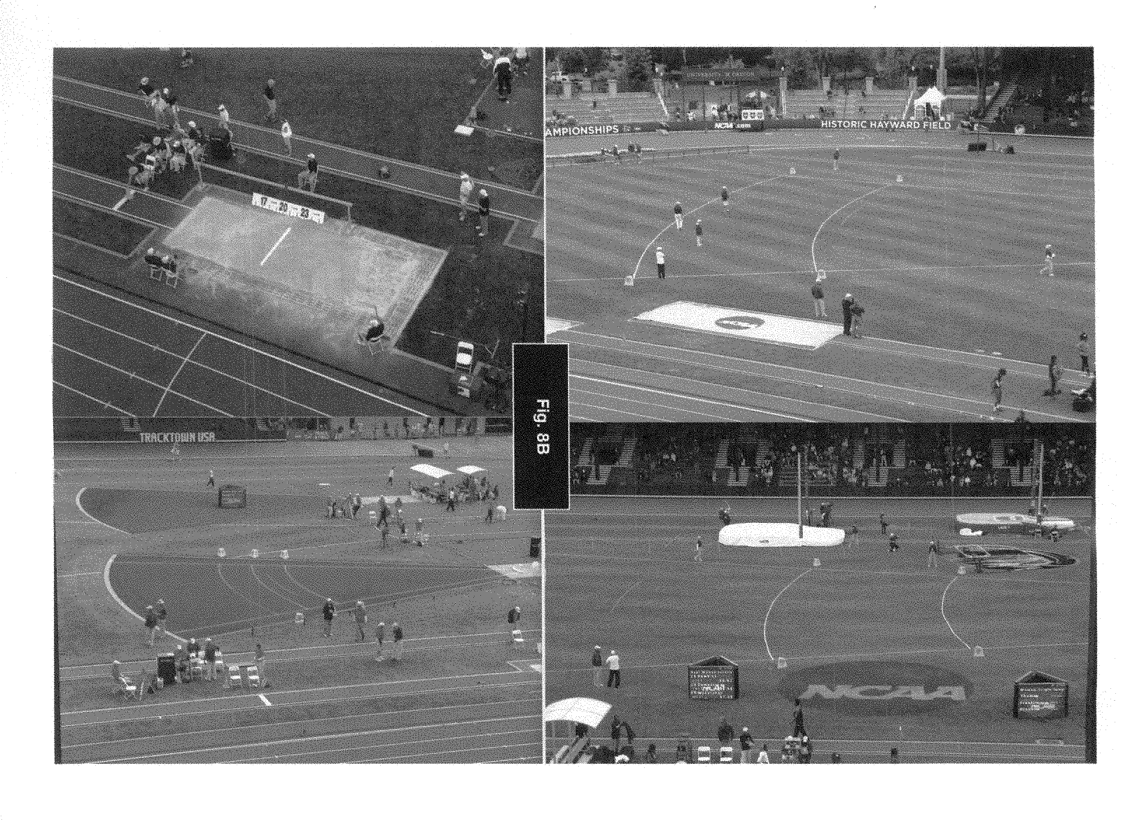

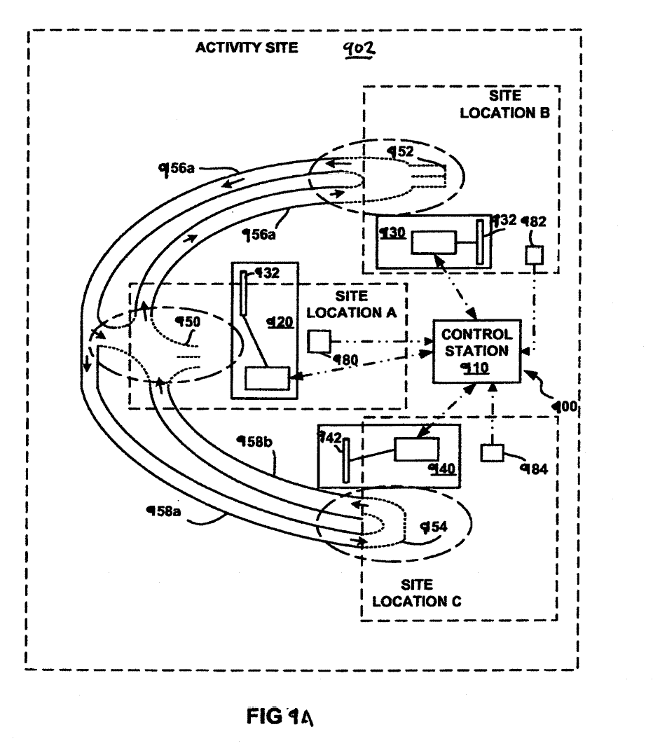

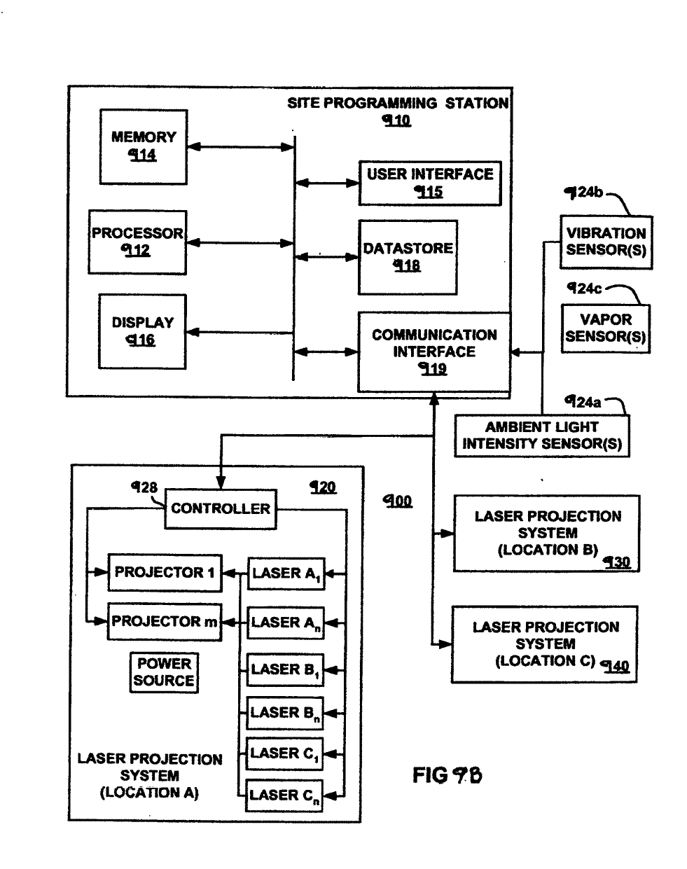

In any event and with reference now to FIG. 7A, there is exemplified a series of temporary markings projected during an athletic event or contest utilizing a projection system such as the one of the exemplary systems depicted by FIGS. 1-6. A variety of such applications are contemplated by the inventor herein. In the context of track and field events, a temporary marker projection system can be employed to generate static, dynamic markers or both. In the former case (which is depicted in FIG. 7A), the markers may correspond to one or more distance measurements statically measured from a fixed origination point. Examples of such measurements include a distance already achieved (or exceeded) by one or more athletes competing in an event, a distance achieved by a current leader in an event, a target distance set by an athlete's coach for training purposes, a distance corresponding to the achievement of a world record holder for the event, or any combination of these. Examples of events utilizing static measurements for which markers are temporary provided according to the present invention include, but are not limited to the shot put, discus or javelin throws, the long jump, and the standing broad jump.

With continuing reference to FIG. 7A, it will be seen that a standing broad jump application of a temporary marker projection system includes a starting zone 600, a landing zone 602 and a temporary marker projecting system 610 which may comprise, for example, system 10 of FIG. 1, system 100 of FIG. 4A and 4B, system 100′ of FIG. 5, or optionally any other system capable of being operated to project one or more temporary visible markers as markers 604, 606 and 608 onto jumping area 602. In the illustrative example of FIG. 6A, marker 604 corresponds to an initial target set for an athlete by his or her coach for training purposes, marker 606 corresponds to a team record (e.g., collegiate or Olympic team) for the event, and marker 608 corresponds to a world record for the event. In the embodiment shown, system 610 includes an operator terminal for local entry of programming commands. Alternate configurations may include a mobile application executable by the processor of a smartphone or other mobile terminal device may be used to display a graphical user interface (not shown) for aligning the output of the laser source (not shown) of system 610 so as to project the markers at the desired location(s).

Dynamic markers are also contemplated as an application for temporary marker projection systems constructed in accordance with the teachings of the present invention. An illustrative example of such an application is shown in FIG. 7B. In this example, commands for system 610 are received over a wireless communication channel from a remote control station 612. In front of, alongside, or behind an athlete (not shown) running on track 620, the position of a temporary marker 626 is continually updated, with respect to the starting time of a currently performing athlete, to show how that athlete's performance compares to at least one of the pace set by the athlete's own best prior performance, the athlete's target pace or pace needed to qualify in a given heat, of the pace set by a prior event participant, winner or record holder. Accordingly, as the position of the marker is continuously updated to move, for example, through points 626, 626′ and 626″, an event participant or trainee (and depending upon the output power of the laser used by system 10, any spectators as well), receives an accurate representation of a selectable pace.

With reference now to both FIGS. 1 and 8A, a process for utilizing a temporary marker projecting system in accordance with the novel method of operation described in connection with FIG. 7A or 7B will now be described. The process 700 is entered at block 702 wherein the projector module is moved and/or elevated to a location suitable for the projection of one or more temporary markers. At block 704, an operator selects between a mode of operation corresponding to fixed distance measurements and a mode of operation corresponding to rate (distance divided by time measurements). The process then proceeds to block 706, at which point the operator specifies the number and location of each measurement to be projected upon the field surface. At block 708, the instructions are transmitted over communication link 90 to control system 28, which energizes laser source 20 and causes the markers to be projected upon the field surface. At decision block 710, the position analysis subsystem continuously monitors the proximity of persons to system 10 and, if a person crosses a proximity threshold, or comes close to entering the path along which optical energy output by laser projector 26 is directed at the field surface, then the process proceeds to block 720 at which point the laser output is disabled for the duration of the incursion. At decision block 712, the light sensing subsystem monitors the ambient light intensity and, while the light level is within safe parameters for class Ma operation, the output of laser source 20 continues in accordance with an empirically derived ambient intensity—laser output curve or at a predetemined level selected for the expected range of conditions. If, however, there is a sudden drop in the intensity of ambient light, the process proceeds to block 720 at which point the laser output is disabled for the duration of the intensity falloff. At decision block 714, if no interrupt command is received from the operator, operation of the laser continues as before and the process returns to block 710.

FIG. 8B depicts respective views showing an arrangement of line segments projected upon exemplary target surfaces according to one or more embodiments consistent with the present disclosure.

To maximize production output, certain work site activities may take place on a continuous (i.e. “round-the-clock”) basis. Such is the case, in particular, in those activities driven by high capital investment, in which the equipment used is very specialized and acquired at high cost. At a mining site, for example, it is not uncommon for large dump trucks to shuttle back and forth between the same two stations many times over the course of a day, and for these trucks to be operated in shifts so that they are always in use (other than for refueling or maintenance). At one location, a load of ore may be dumped into the bed of the truck. At another, the load is dumped into a crushing pit. This circuit is repeated many times throughout the course of a 24-hour day, by each of a plurality of trucks, with the steady stream of ore being needed to feed a continuous processing operation which, if interrupted, results in lost productivity and in lost profits to the mine operator/owner. The inventor herein has observed that vehicles approaching a site of the type exemplified above are operated by highly skilled drivers. However, even for such drivers, it is a challenge to properly align the vehicle perfectly, the first time, every time. The risk of damaging adjacent structures or equipment is ever present. While guiding markers could theoretically be used, these are subject to damage and would restrict movement of vehicles and equipment in the vicinity of the discharge station or other facility being approached. Paint applied directly to the surface, on the other hand, would quickly deteriorate and/or be obscured by shifting sand, rocks or dirt.

Some embodiments consistent with the present disclosure provide a visible reference aid to guide vehicles and equipment at an activity site characterized, for example, by continuous operation and/or long operating cycles. Over a 24 hour operating cycle, for example, a system constructed according to embodiments consistent with the present disclosure may serve as a reference aid in conditions that include full daylight, twilight, and darkness.

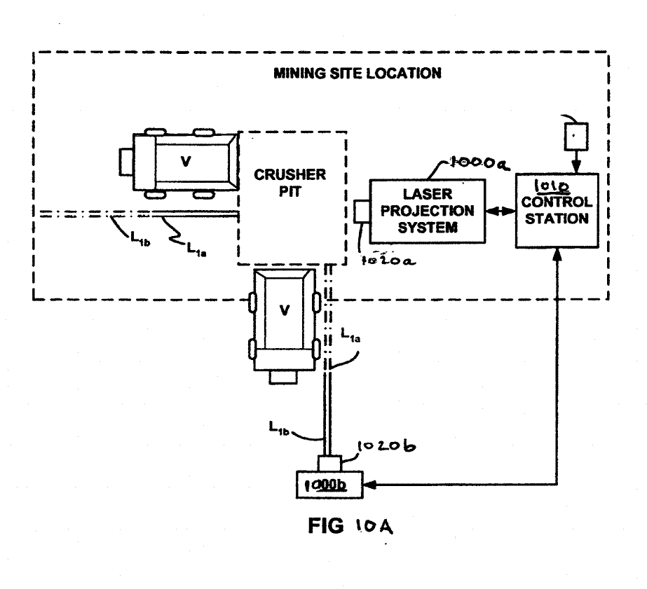

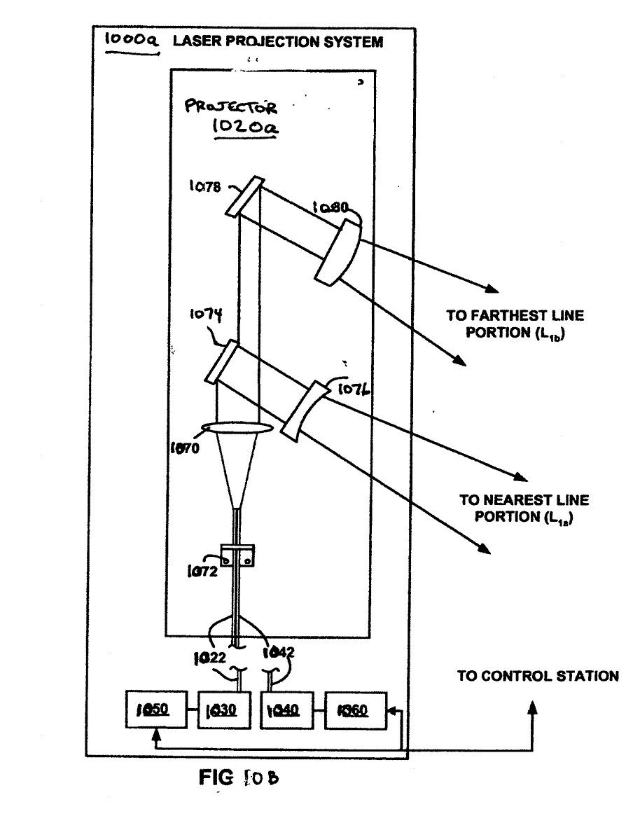

In FIG. 9A, there is shown a block schematic diagram depicting a continuous aid reference marker projecting system 900 operative to provide at least one reference line at each of a plurality of site locations at activity site 902. Three of these site locations—indicated generally at Site Location A, Site Location B, and Site Location C—are shown in FIG. 1. According to embodiments, system 900 includes a central site control station (computer) 910 which is communicatively coupled to a plurality of laser projecting systems including laser projecting systems 920, 930 and 940 disposed at Site Locations A, B and C, respectively. Components of each of laser projecting systems 920, 930 and 940 include a laser controller and one or more lasers (FIG. 9B) as well as a projector indicated generally at reference numerals 922, 932 and 942, respectively. A plurality of sensors, as sensors 924, 934 and 944 disposed at one or more locations within each of the site locations having a laser projection system, provide input to central site control station 910.

According to some embodiments, at least one of the sensors is a commercially available ambient light intensity sensor, operating on the principles of devices used by photographers to detect lighting levels during photography sessions. The ambient light sensors are operative to detect variations in the amount of light at the site location over the course of an activity period. While an activity period may vary in duration, and may be interrupted for such reasons as scheduled maintenance, unanticipated equipment failure, or safety reasons, embodiments of the invention are operative to project a visible line for extended periods of time which may range from a few hours to a few days to a few weeks and even to months or years of uninterrupted operation. During night time (artificial light only) operation, a much smaller amount of laser output is required. In full daylight, on the other hand, the full output of several lasers may be required to generate a reference aid bright enough to be seen. Responsive to input provided by ambient light sensors located at each site location, the output of each laser projecting system as system 920 is adjusted so that a visible light is generated at all times. According to some embodiments, such dynamic adjustment comprises selecting one of a plurality of output levels according to whether the detected level of ambient light intensity falls within a range associated with the selected level.

According to some embodiments, projectors 922, 932 and 942 are configured with movable x-y scanning heads so, for example, that the complex lane pattern as patterns 950, 952 and 954 shown at Site Locations A, B and C of FIG. 9A, respectively, are defined. In this regard, an entire site routing plan, including lanes 956a, 956b, 958a and 958b can also be defined using additional laser projecting systems (not shown) to the extent one or more of the site locations is subject to relocation and/or alteration. By designing and projecting inter-station routes immediately after relocating a processing station or otherwise altering a site flow, transitional periods which might otherwise be characterized by higher latency, higher fuel costs and/or a higher accident rate are substantially avoided. After equipment and vehicle operators become accustomed to the new flow, operation can (though it need not) be limited to just the processing locations themselves.

According to some embodiments, projectors 922, 932 and 942 utilize one or more scanning projector and control arrangement of the type disclosed in U.S. Pat. No. 7,219,438 entitled SYSTEM FOR OPERATING ONE OR MORE SUSPENDED LASER PROJECTORS TO PROJECT A TEMPORARY VISIBLE IMAGE ONTO A SURFACE. Closed-loop galvanic scanners (also called “position detecting” scanners), for example, are commonly used in the laser light entertainment industry and are capable of directing a beam to 24,000 to 30,000 discrete points along a selected path every second.

With particular reference now to FIG. 9B, elements of illustrative system 900 are shown in greater detail. According to embodiments, site programming station 910 is implemented as a general purpose computer and comprises a processor 912, a memory 914, a user interface 915, a display 916, a data store 918 and a communication interface 919.

As noted previously, a purpose of station 910 is to control the operation of the respective laser projector systems 920, 930 and 940 responsively to inputs received from a plurality of sensors as sensors. Electrical signals representative of the detected sensor values are received at communication 919. According to some embodiments, these signals are wirelessly transmitted by at least some of the sensors, with each sensor having a unique identifier such as a media access control (MAC) address or other means of identifying itself to control station computer 910. An exemplary ambient light intensity sensor 924a associated with Site Location A is shown in FIG. 9B.

Processor 912 executes instructions stored in memory leading to a comparison between a detected ambient light value and a series of reference ranges stored in datastore 918. According to some embodiments, each reference range represents that range of detected ambient light values at which one or more lasers operated individually or in combination produce a reference aid of sufficient visibility as to be useful to vehicle and equipment operators. According to other embodiments, a set of operating set points corresponding to a performance curve may be fixed by software, wherein this operating curve is used as the reference by which the output of each laser or each laser source is modulated with respect to time. As will be readily appreciated by those skilled in the art, the sensory input is not required during times of artificial lighting (i.e., after sundown and before sunrise) so dynamically variable operation according to a sensory input approach, as exemplified above, is preferably suspended during such times.

According to some embodiments, the processor 912 of control station computer 910 is responsive to input from light intensity sensors as sensor 124a, at Site Location A, to immediately disable the output of the associated laser projection system 920 when a reduction in the intensity of ambient light is so rapid as to cause the pupil of the average human eye to dilate sufficiently to expose that eye to levels of visible laser radiation in excess of the accessible emission limits contained in Table II of 21 CFR. Subchapter J Part 1040.10 (i.e., above the threshold for Class IIIa mode of operation under rules promulgated by the LS. Center for Devices and Radiological Health.

Other types of sensors which may be processed by processor 912 of station 910 include vibration sensors and vapor sensors 924b and 924c, respectively, associated with Site Location A. When a level of vibration indicative of an explosion is detected by sensor 924b, which is predictive of a disruption in operation, an unsafe operating condition, or a strong possibility of system component misalignment, control station computer 910 instructs the laser projection systems affected by the condition to shut off until the issue is resolved. Likewise, vapor sensor 924c is configured to characterize and determine the level of explosive vapors in the atmosphere surrounding a site location as Site Location A (FIG. 1). If this level is above the lower explosive limit (LEL) or below the upper explosive limit (UEL) and therefore indicative of an unsafe operating environment, control station computer 910 transmits a signal to corresponding laser projection system 920 and causes the system 920 to shut down until the issue is investigated and/or resolved.

It will be recalled that in the embodiment depicted in FIG. 1, a movable projector—allowing the projection of complex site location routing patterns to be defined—is contemplated. To define such patterns, instructions are stored in memory 914 and executable by processor 912 to allow the system operator to define the pattern associated with site location. User interface 915 and display 916 may be used for this purpose or, optionally, a mobile terminal such as a laptop, notebook or tablet computer operative to exchange communication signals with control station computer 910 via interface 919 can be used so that the pattern being defined can be viewed in real time while the operator is standing at the applicable site location being programmed.

With continued reference to FIG. 9B, it will be seen that each laser projection system as system 920 can include one projector or multiple projectors as projectors 1 to m, a plurality of lasers as lasers A₁ to Aₙ, B₁ to Bₙ, and C₁ to Cₙ and a power source for supplying power to all of these various components. According to some embodiments, one or more lasers and a projector constitute a single laser source. According to the embodiment of FIG. 9B, any laser or group of lasers among lasers A₁ to Aₙ, B₁ to Bₙ, and C₁ to Cₙ is operative to feed any one or all of projectors 1 to m.

Multiple projectors as shown in FIG. 9B are especially suited for complex reference aid shapes and lane patterns, particularly when bi-directional paths are to be defined in manner depicted in FIG. 1. For reference aids comprising only a single line, however, a single projector with stationary components (i.e., without moving parts) may be coupled to each of one or a plurality of lasers by corresponding optical fibers. An embodiment of the latter will now be described with particular reference to FIGS. 10A and 10B.

FIG. 10A depicts a specialized site location of a mining activity site. In the illustrative embodiment, the site location is an ore processing facility which includes a crusher pit. Before a large dump vehicle V can empty the contents of its bed into the crusher pit, it must approach and back into the correct location without damaging any of the adjacent equipment or other portions of the facility. A preferred alignment requires a longitudinal axis of the vehicle V to be orthogonal to the sidewall of the pit. According to embodiments of the invention, this alignment is achieved by reference to one or more simple reference lines as reference lines L₁ and L₂ projected by laser projection systems 1000a and 1000b, respectively. One or more sensors as ambient light sensor 302 provide input to control station computer 1010. In all material aspects, the construction and programming of control station computer 1010 is the same as that described in connection with control station 910 of FIGS. 9A and 9B except to the extent that the projectors 1020a and 1020b are not of the scanning type and therefore may not permit the rendering of complex line and lane patterns (e.g., of the type shown in FIG. 9A).

An exemplary projector useful, yet simple, reference aids according to embodiments is disclosed in FIG. 10B. In this example, laser projection system 1000a includes a fiber fed projector 1020a which receives the output of two lasers 1030 and 1040 is via first and second optical fibers, indicated generally at reference numerals 1032 and 1042, respectively. Each laser is, in turn, operated by a corresponding laser controller 1050 and 1060, respectively. Each of laser controllers 1050 and 1060 are communicatively coupled to and under the operative control of projector control station 1010. It should be noted that although the functions of the control station 1010 and laser controllers 1050 and 1060 are described in connection with one embodiment as being separately performed by a distributed network of communicatively coupled modules, it should be readily appreciated by those skilled in the art that in other embodiments appropriate hardware can be incorporated into computer 1010 to perform any and all of the functions typically performed by a laser controller such, for example, as power on, power off, diagnostics, and power level modulation.

In any event, and with continued reference to FIG. 10B, it will be seen that according to some embodiments, projector 1020a includes a biconcave, collimating lens 1070 which receives the output of lasers 1030 and 1040 via fibers 1032 and 1042. The fibers are maintained in a precise registration with collimating lens 1070 by a retaining block 1072 mounted within a projector housing. A portion of the collimated beam emitted by lens 1070 is reflected by a first or lower mirror 1074 into a plano-convex lens indicated generally at reference numeral 1076. The output of lens 1076 which projects optical energy onto the ground to define the nearest portion of line L1 indicated generally at L₁ₐ in FIG. 10A. The remaining portion of the output of the collimated beam output by lens 1070 is reflected by a second or upper mirror 1078 into a plano-concave lens 1080 which projects optical energy onto the ground to define the farthest portion of the line L1 indicated generally at L_{1b} in FIG. 10A. Projector 1000b is constructed in like fashion.

It will,of course, be readily appreciated by those skilled in the art that a variety of other projection module mounting configurations are possible besides those exemplified by FIGS. 9A-10B.

For a line width of approximately 6 inches), excellent results in full daylight ambient lighting conditions have been achieved using two lasers each operated at 50 W. Suitable lasers include frequency doubled, Q-switched Nd:YAG laser adapted to generate laser pulses at a wavelength of 532 nm. Emission at this wavelength is especially preferred since it is very close to the peak (555 nm) of the human eye's sensitivity. By comparison, in an argon ion laser operating in continuous wave (cw) mode, roughly half of the output is at 514 nm (58% as bright as the same beam at 555 nm), another 30% is at around 480 nm (18% as bright) and the remaining 20% is at around 440 nm (barely visible to the human eye). Thus, an argon laser would theoretically have to deliver up to three or four times as much power to match the visibility of the Nd:YAG laser.

With simultaneous reference now to FIGS. 9A, 10A and 11, a process for utilizing a continuous reference aid projecting system in accordance with novel methods of operation will now be described. The process 1000 is entered at block 1102 wherein one or more projection systems constructed in accordance with embodiments of the invention have been installed at one or more activity site locations and these have been communicatively coupled to and are operative under the direction of a control station computer configured to receive input from one or more sensors located at one or more of the activity site locations. At block 1104, a request is received to continuously project at least one line at an activity site for the duration of an activity period. The period activity may be of finite duration (i.e. specifed in the request) or of infinite duration (subject only to manual override by an operator or an interruption in operation due to power loss or the detection of an unsafe operating condition or other specifiable event).

At block 1106, the method energizes one or more laser sources are energized (as lasers A₁ to Aₙ of FIG. 2 or lasers 1030 and 1040 of FIG. 10B) and at block 1108. The process then proceeds to decision block 1110. If a substantial enough change in the level of ambient light is detected, such that a change in operation is required to maintain visibility and/or minimize power consumption (i.e. an ambient lighting measurement is received from a sensor which is brighter or dimmer than the preceding measurement interval), then at block 1112 the output of the applicable laser source(s) is/are modified. Otherwise, the method proceeds to decision block 1114. If an interruption event is detected, then at block 1116 operation is suspended for the duration of the interruption event. Otherwise, the process proceeds to decision block 1118. If no end point was specified in the request received at block 1104, the process returns to block 508. If an endpoint was specified, the process proceeds to decision block 1120. If the specified endpoint has been reached, the process terminates at block 1122. Otherwise, the process returns to block 1108.

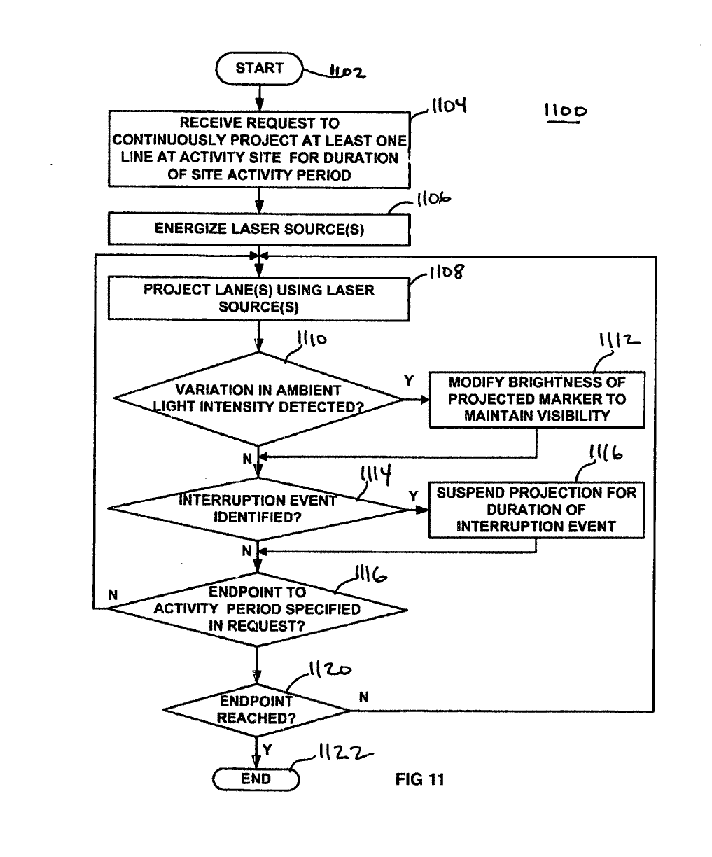

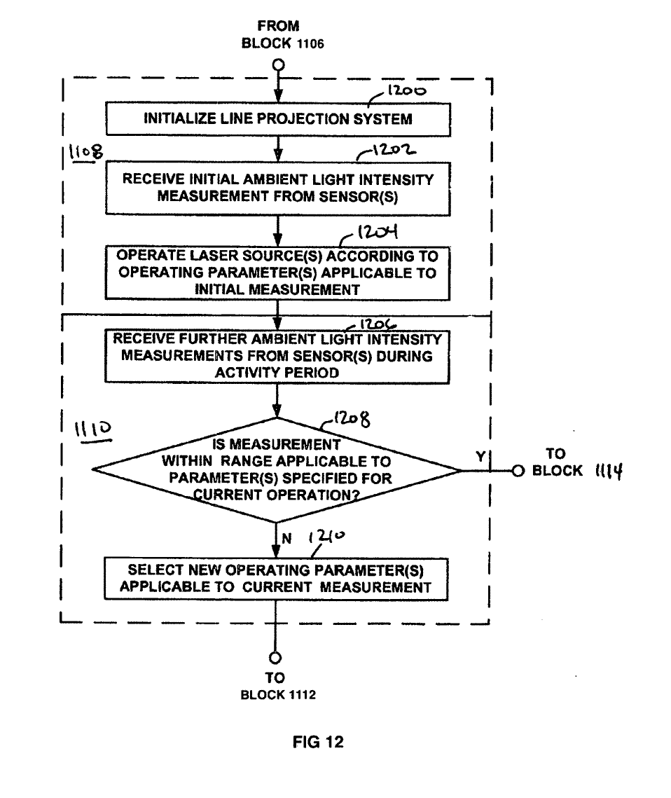

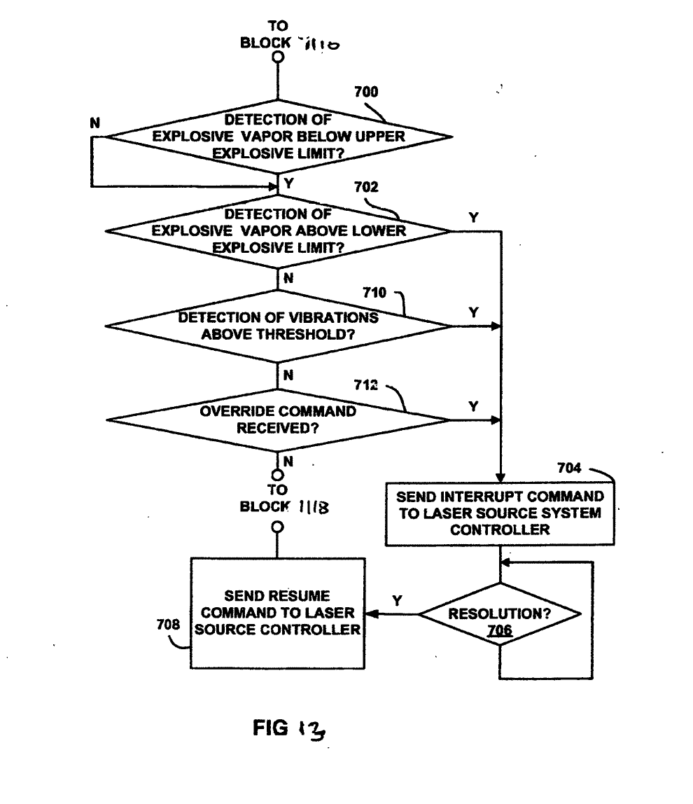

Turning now to FIG. 12, an embodiment of the illustrative process of FIG. 11 is depicted in greater detail, with particular emphasis on blocks 1108 and 1110. According to embodiments, block 1108 encompasses, at block 1200, a step of initializing the line projection system. Typically, this includes performing a self diagnostic test to verify that all components essential to safe operation are in proper working order. Such components include the sensors, the signaling interfaces between control station computer 910 (FIGS. 9A and 9B) or 1010 (FIGS. 10A and 10B) and the respective laser controllers, and the like. An operator of the control station computer may be prompted to confirm proper operation at this time.

The process of block 1108 proceeds to sub process block 1202, wherein an intial light intensity measurement is received and processed. According to some embodiments, a light intensity sensor may be present at each activity site location. Alternatively, a single light intensity sensor may be used. The measured value(s) is/are stored in the memory of the control station computer and, according to some embodiments, the computer processor selects an initial laser output power requirement based on the measurement(s). At 1204, one or more laser source(s) are operated according to the selected output power requirement.

In some embodiments, a respective, satisfactory power level is stored for a corresponding range of measured values. If the measurement(s) fall within one of these ranges, the applicable power level is selected for the laser(s) associated with at least the activity site location at which the sensor measurement was acquired. At sub-process block 1208 of block 1110, as new ambient light intensity measurements are acquired at sub-process block 1206, they are compared as described above to determine whether they are still within the range determined for the preceding interval. If so, the process returns to block 1114 (FIG. 11). If not, the processor of the control station computer selects, at sub-process block 1210, an updated power output level and sends a command or other signal to the applicable laser controller(s) to initiate laser operation at the selected, updated power output level. In embodiments, the aforementioned command is processed and operation at the modified brightness level begins.

With reference now to FIG. 13, there is shown a series of optional steps associated with the identification and handling of interruption events as a sub-process within block 1114 of FIG. 11 according to some of the embodiments of the invention. The sub-process begins at decision block 700, at which point a determination is made as to whether or not an explosive vapor is detected by one or more sensors to be at a level below the upper explosive limit. If so, a further determination is made at block 702 as to whether the explosive vapor is also present at a level above the lower explosive limit. Since operation in this range is highly dangerous, in the event the outcome of this determination is also yes, then the process proceeds to block 704. At block 704, an interrupt command is sent to the laser source controller(s) in the location of the sensor. Once the situation is resolved (at block 706), which may require confirmation by an operator or may be automatic based on an extended (say, for example 1 hour) period of readings below the lower explosive limit, a resume command is transmitted at block 708 to the laser source controller and operation resumes.

Returning to block 700, it should be noted that if a level of explosive vapor is detected which is above the upper explosive limit, this too may be processed by control station computer 910 or 1010 (FIG. 9B or 10B) to suspend operation the lasers and associated controllers. In any event, assuming no or only permissible amounts of an explosive vapor in the atmosphere, the process proceeds from either of blocks 700 and 702 to decision block 710. At decision block 710, if a vibration sensor at an activity site detects the existence of vibrations indicative of an unsafe operating environment such, for example, as an explosion or other accident, then the event is processed by the processor of computer 910 or 1010 and all laser sources responsive to sending and processing of an interrupt event command at block 704 as above described. Likewise, at block 712, if an override command is received—whether by a local pushbutton operator at the location of the reference aid or by action of the control station computer operator—the interrupt event command is transmitted to the laser source(s) affected until the situation is resolved. If not interrupt events are detected or if the detected event(s) are resolved, then operation proceeds to block 1118 of FIG. 11.

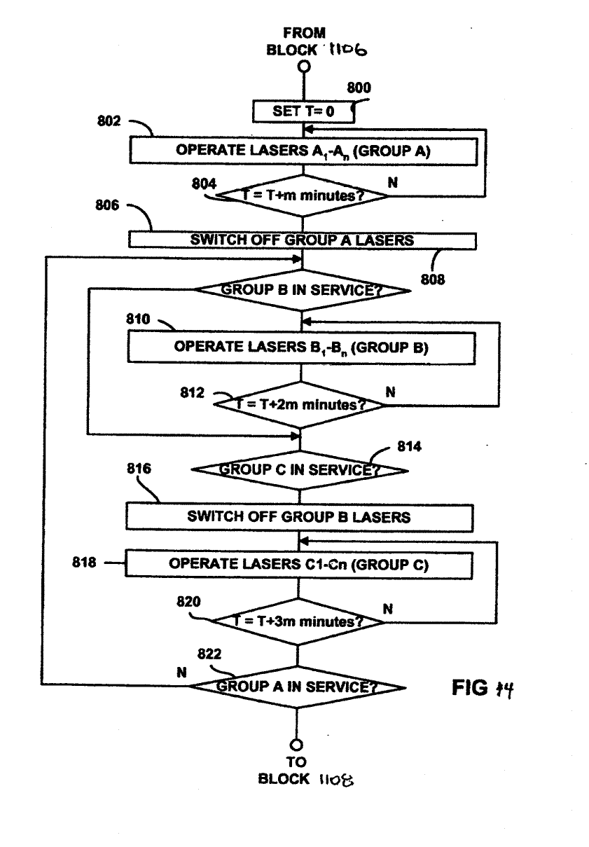

With final reference now to FIG. 14, there is shown optional arrangement for operating subsets of lasers in round-robin fashion as part of a reference aid projecting system according to embodiments of the invention. As seen in FIG. 14, which proceeds from block 1106 of FIG. 11, an operating interval time T is initialized to zero at block 800 and at block 802, a first subset of lasers, as lasers A₁ to Aₙ of FIG. 2, are operated during a time T+m minutes. M may be any number and may, in fact be measured hours or days rather than in minutes. The objective is to provide redundancy and ensure the projection of a visible reference aid over an extended period of time. According to some embodiments, m is a period of between 60 and 6000 minutes (i.e. 1 to 100 hours). At decision block 804, it is determined whether operation of the first subset of lasers has been for m minutes and, if so, these are switched off at block 806 and a determination is made at block 808 whether a second subset (Group B) are operational. If so, these are then operated at block 810 for another m minutes. If the lasers of Group B are not determined to be operational at decision block 808, or after determination at block 812 that operation of those lasers has proceeded for m minutes, the process proceeds to block 814, at which point a determination is made as to whether the lasers of Group C are operational. If so, the lasers of group B are switched off at block 816, and operation of the lasers of Group C proceeds at block 818 until, at block 820, it is determined that these lasers have been operated form minutes.

Continuing with the example of FIG. 8, if the lasers of Group C are not determined to be operational at decision block 814, or after determination at block 820 that operation of those lasers has proceeded for m minutes, the process proceeds to block 822, at which point a determination is made as to whether the lasers of Group A are operational. The process then proceeds to block 1108 of FIG. 11 and is ready for the next cycle of operation.

In other embodiments consistent with the present disclosure, a camera and or algorithm and or a computer program determining the information of a still or moving object and then, based on calculations or a set of entered instructions sent to a laser line projecting apparatus mounted to a guy wire delivery system, the projecting apparatus is selectively movable along and above the center of a target surface such, for example, as an athletic field, and or stadium. In an embodiment, the projecting apparatus is dimensioned and arranged to project at least one fixed and or temporary, visible reference first down laser line or a touch down laser line onto a playing surface.

A camera and or a learning programmed computer system or a switching remote controlled wireless device consistent with present disclosure comprises a movable laser source and projector system on a guy wire structure that is dimensioned and arranged to be supported by and project onto a target on the field of play. The system may further include a remotely located larger laser source (not limited to) connected via fiber optic cable (or the actual larger laser source itself) to a mounted on a guy wire system moveable up and down the field which is supported by the movable structure, the laser source being maintained remotely (or mounted on the guy wire system itself) in another loaction and the laser line projector moves by the movable structure (or mounted in one or more different locations) at an elevated location relative to the target playing field surface. This allows the camera's view and laser projected source to direct optical energy (not limited to) directly downward upon the field or stadium while the movable structure (or still mounted) is maintained substantially in a first orientation relative to the target playing surface. The learning algorithum anticipates the movements of objects and things on the field in the stadium to determine the location of the projected first down or touch down laser line, (not limited to) to display a specific laser line across the field directly from overhead to show the players, officials, coaches, fans in the stands and on all the cameras different angles broadcasting the event where the usually invisible first down line really is.

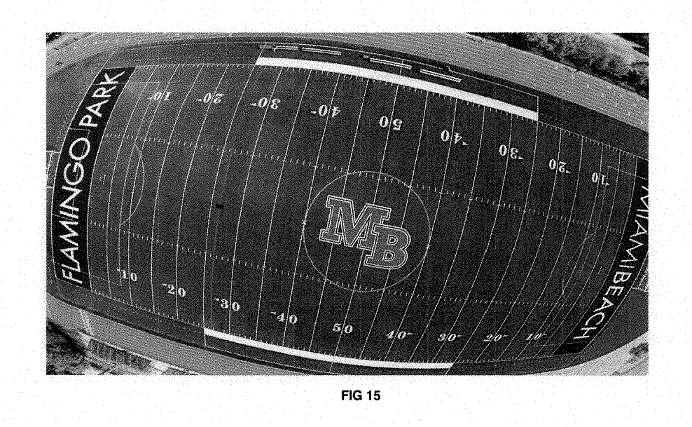

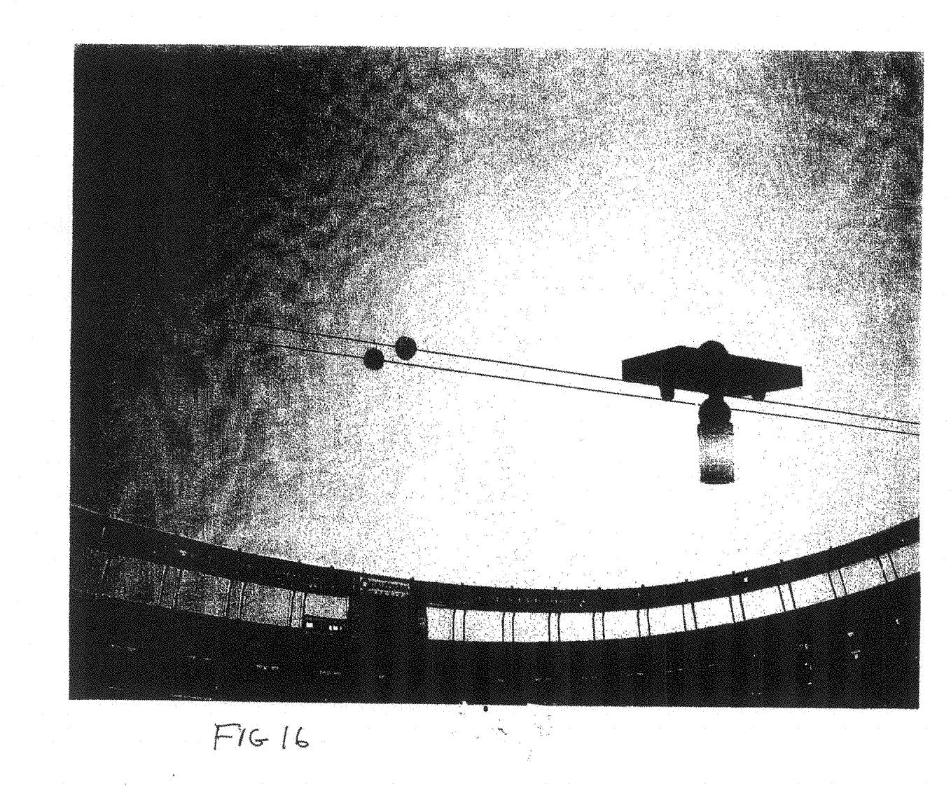

FIG. 15 depicts projection of a visible first down line onto a target surface by an overhead laser projecting apparatus suspended and moved by wires according to one or more embodiments, the projecting apparatus receiving optical energy from one or more laser source(s) by via one or more optical waveguides (e.g., optical fibers) and being movable into a location suited for projecton of a reference line onto a target surface (e.g., at the exact overhead location pointed direcly down required by the official location of the first down marker on a playing field).

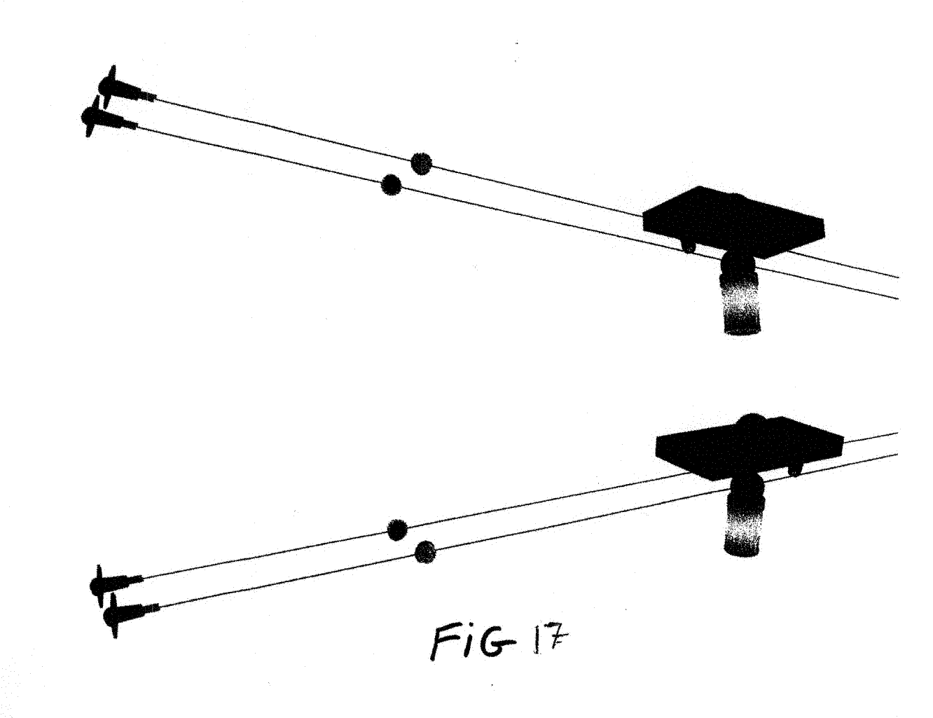

FIG. 16 depicts operaton of a system according to an embodiment of the invention projecting a fiber optic fed (or no fiber optic used if the laser source is on board the moveable guy wire delivery system itself) up and down the field remotely controlled by computer moveable guy wire delivery system, first down laser line pointed onto an exact mark on the playing field. Either determined by the referee and or by the operator.

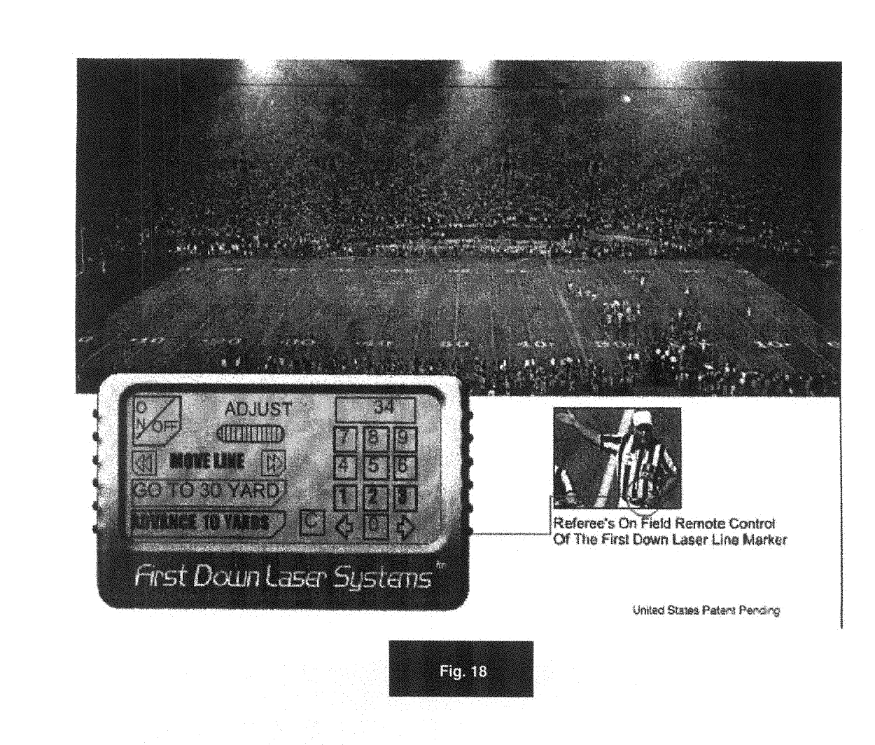

FIG. 17 is an example of system according to an embodiment of the invention travel delivery system mounted to both ends of the stadium over head so as to deliver a projected first down laser line onto the playing field for all to visibly see and use during a game. The system provides a temporary visible reference mark upon a surface despite dynamically variable ambient lighting conditions, and comprises a laser source positional at the elevated location relative to the target surface. The laser source platform is carried by a mobile platform suspended by guidewires, the guide wires being actuated by one or more controller(s) that are connected to a computer having a processor executing instructions stored in memory of the computer to learn and anticipate directions and corresponding projected line locations based on movement and positions of the mobile platform and/or wire spooling. Based on the acquired line location data, and/or on specifically input instructions by an operator, the system is able to project a laser line or graphic onto the playing field target surface (e.g, for a first down line visible for reference purposes in a football game)

In some embodiments, the system of FIGS. 16 and 17 further includes a laser source positionable at an elevated location relative to the surface and operative to direct optical energy at a wavelength of between 380 nm and 750 nm upon the target surface, an ambient light sensor dimensioned and arranged to detect variations in an intensity of sunlight in a zone proximate the surface so as to approximate an intensity of sunlight or ambient light striking the target surface, and a laser source modulating system and or defusion line generator operatively associated with said ambient light sensor and operative to one of reduce and disable an output of said laser source when a level of ambient light intensity detected by said ambient light sensor falls below a selectable threshold. In an embodiment, the system projects a line downwardly in a direction orthogonal to the target surface so as to define a reference plane. An array of photosensors and/or a camera arrnged to accommodate image analysis within the defined reference plane may be used to detect upon the ball breaking the plane of the laser line to give a notice of the event to alert making of the first down and or a touch down.

In some embodiments, the system of FIGS. 16 and 17 projects the aforementioned reference plane along some or a portion of a goal line. The system is further configured to detect when a ball breaks the plane of the goal line evidencing a touch down. In an embodiment, the system is used in combination with a camera algorithm on the ground to see if a knee of the player in possession of the ball had touched the ground before the ball broke the plane of the goal line (as made visible by projection of the line). Such operation enables a determination whether a touch down was scored or not. Another application of the system consistent with the present disclosure is to define a plane above and between the goal posts during a football game. Even when a ball is kicked and its path of travel is along an arc taking it higher than the physical goal posts, a system constructed in accordance with the present invention enables a determination of our whether or not a kicked ball was between the goal posts such that only a valid field goal or extra point may be awarded.

In an embodiment, a system consistent with the present disclosure comprises controlling a laser projector and or its fiber optic cable directly above a playing field for the laser source to be projected out safely away from the audience and the players on the field, by projecting the laser line for delineation from directly above overhead for the first down line to be marked on the playing field. Movement of the projector can be directed from a remote control unit (e.g, via transmitted RF control signals or direct wire control) the movement from the zero yard line on one side of the field end zone, to the zero yard line on the other side of the end zone (from goal line to goal line in very small exact increments). The fiber optics connected to the laser projector mounted to the platform in a trough along the middle of the two guy wires—or a single guy wire and or without a fiber optic cable—with a stabilizing mechanism, that if using fiber optics—coils up the fiber optics feed on a reel when the projector moves in one direction, and coils out from the reel when the projector is moving in the other direction. Up field or downfield. Coiling when going down filed and unwinding the coil when going up field. This movement can be controlled manually and or by computer algorithm control.

If controlled by a computer, a system consistent with the present disclosure may be programmed to sense the marking of the tip of the ball by a referee's placement of that ball and the first down line would appear at what ever exact location is either punched in to the computer, determined by the camera or instructed verbally by the voice of the referee or operator into the system. (but not limited to these methods of controlling the line placement) A new guy wire remote controlled and operated delivery system, to mount a fiber optic fed and or not a fiber optic fed, first down laser projector over the top—along the center of a stadium and or playing field. Controlled remotely, wirelessly and or by direct wire to move the laser projector in exact increments up and down the center of the field, directly over the first down laser line marked visibly onto the playing field.

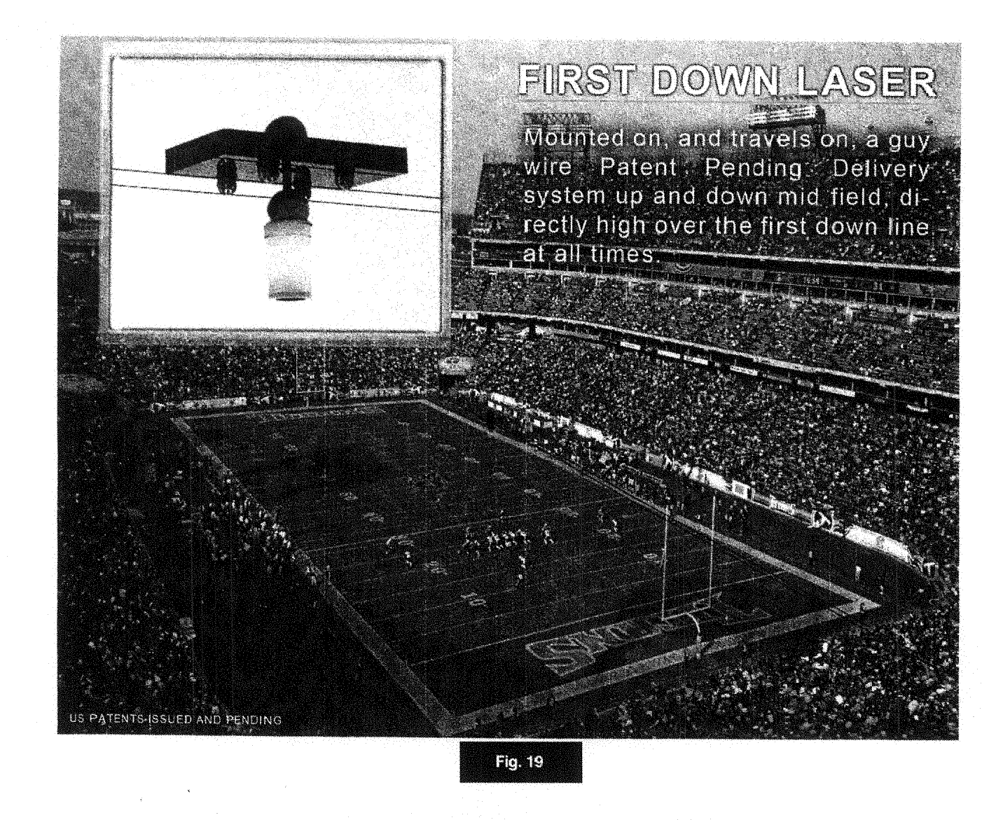

FIG. 18 is an example of a location for a suggested embodiement of a referee held controller for the laser source controlled by our computer program and fiber optic fed or not fiber optic fed using the actual laser source on board the delivery system itself, moveable up and down the length of playing field laser projector system according to an embodiment of the invention.

FIG. 19 is an overhead view of a predetermined projected on to the playing field for everyone in the stadium and on the TV broadcast to visiably use as a first down line and or a touch down line use reference and or to alert of a first down and or a touch down.

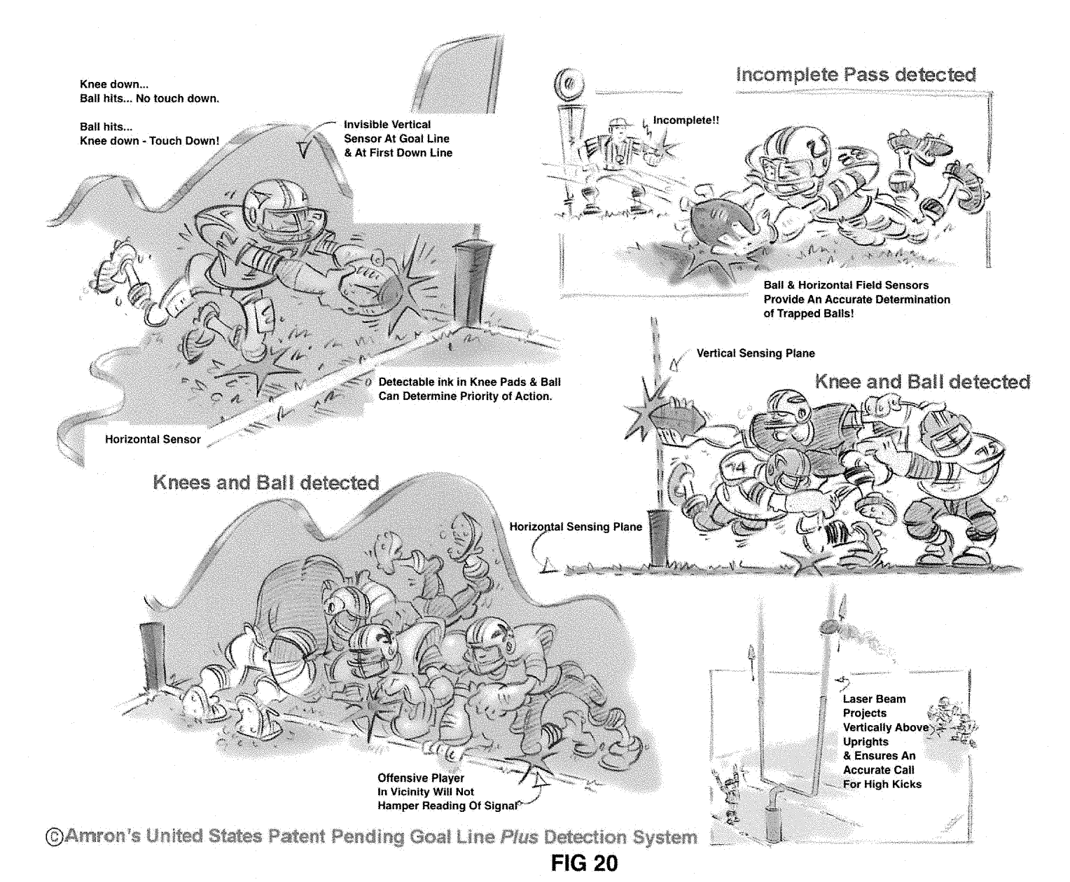

FIG. 20 are examples views of detection systems on to the playing field for our first down laser line breaking notice, touch down goal laser line alerts with knee down first.

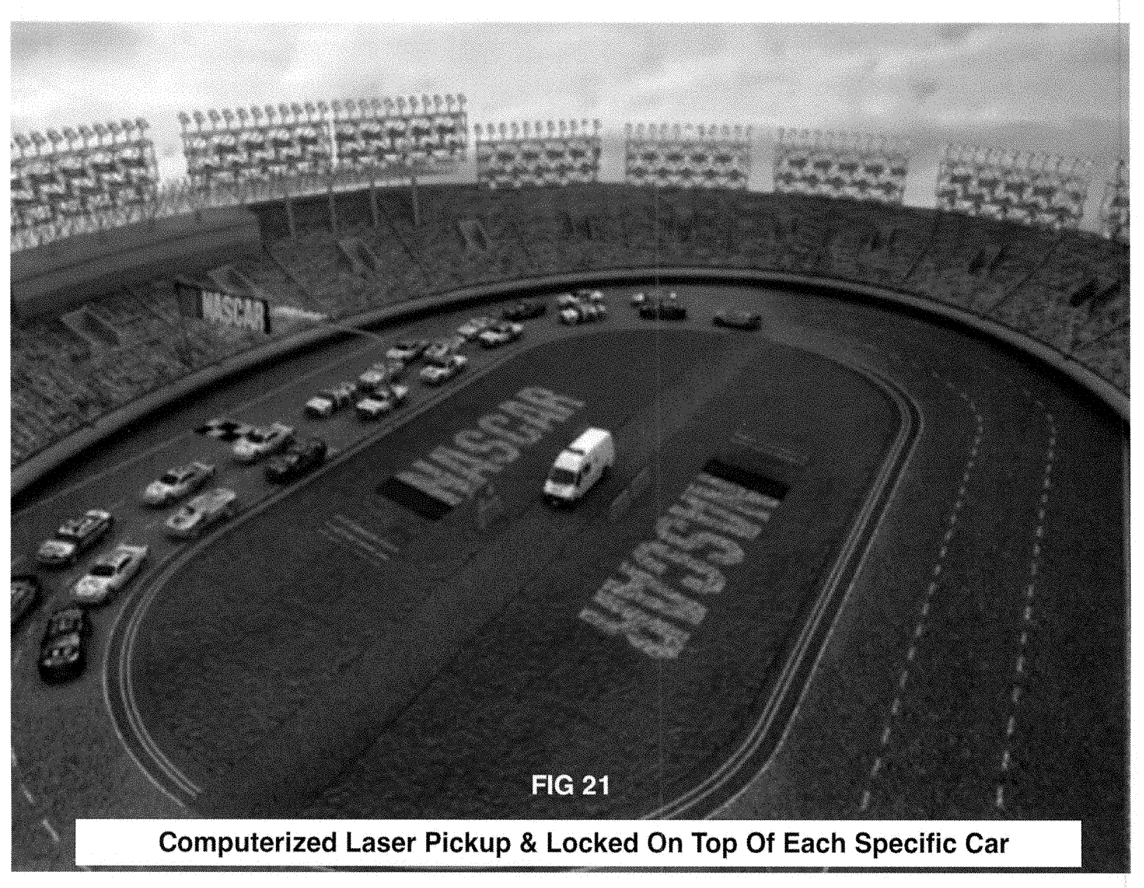

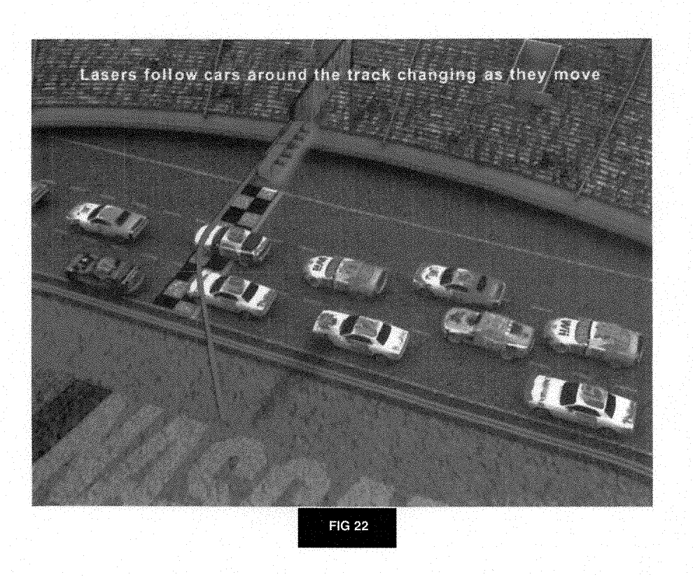

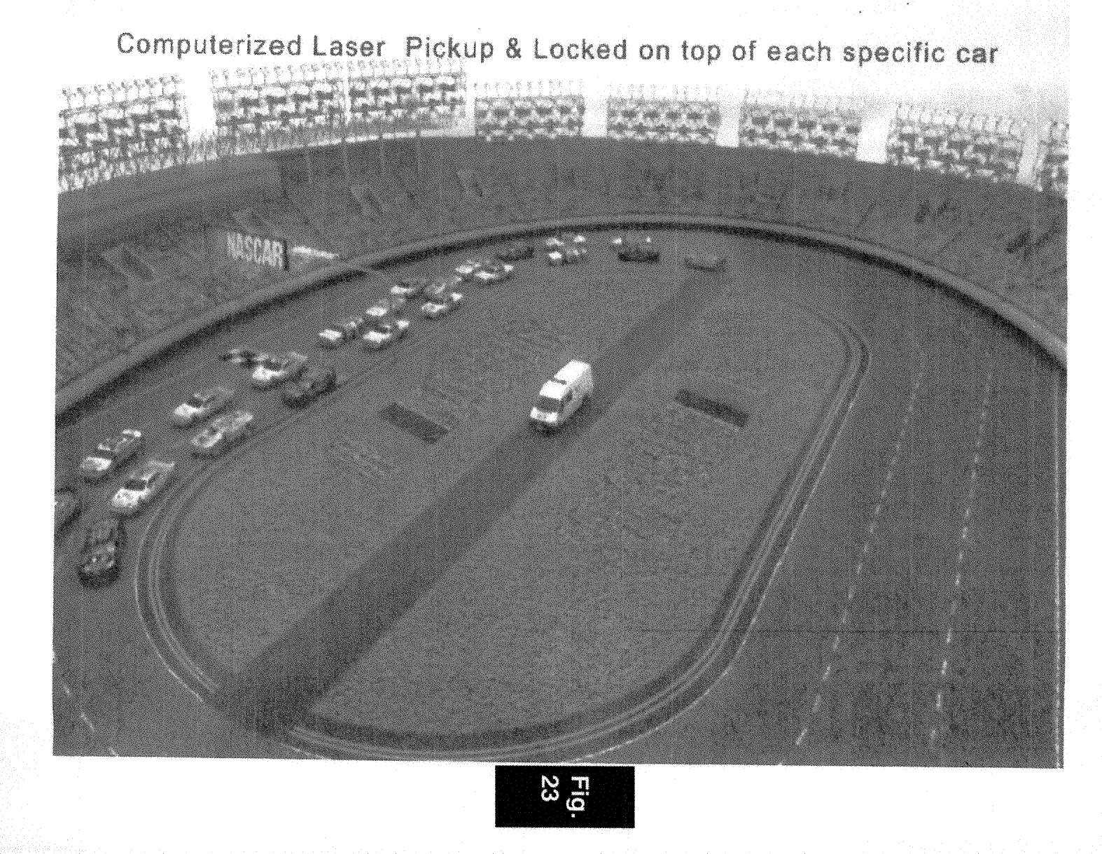

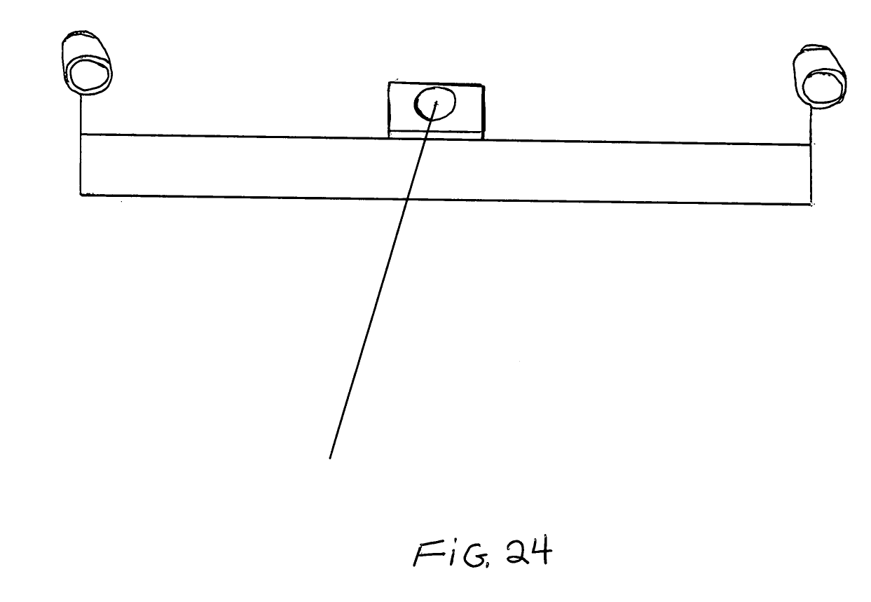

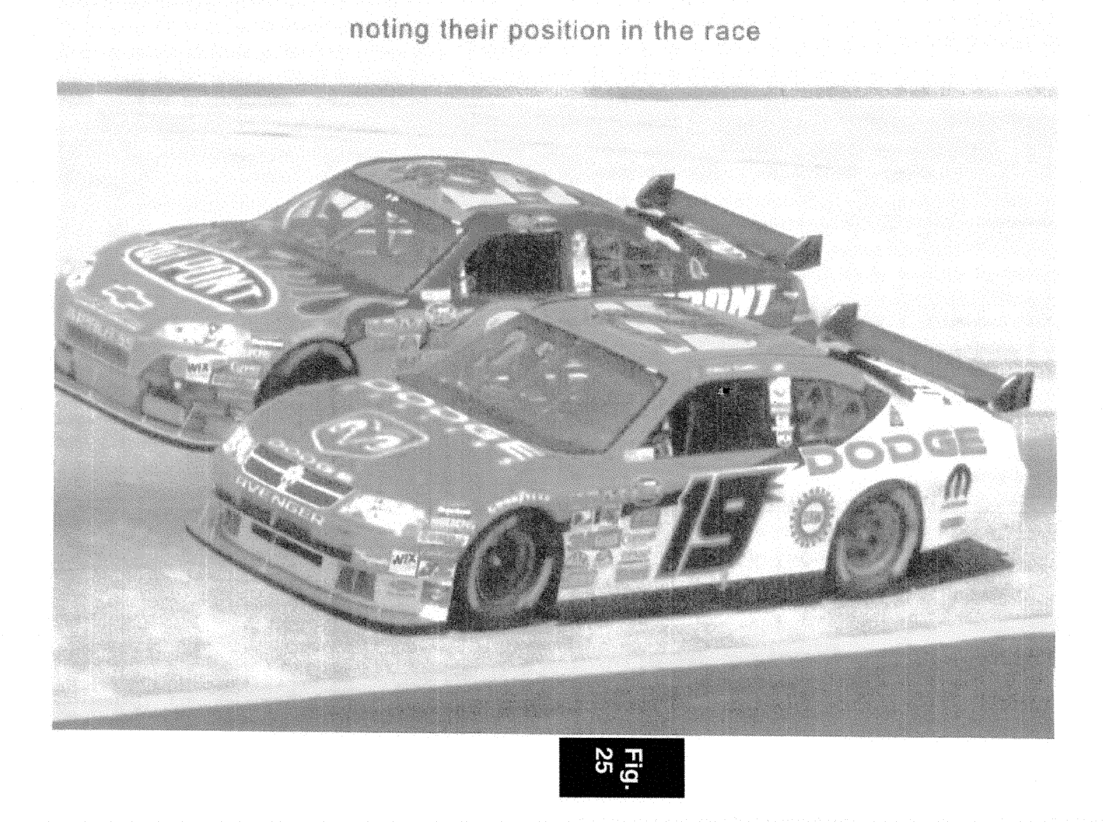

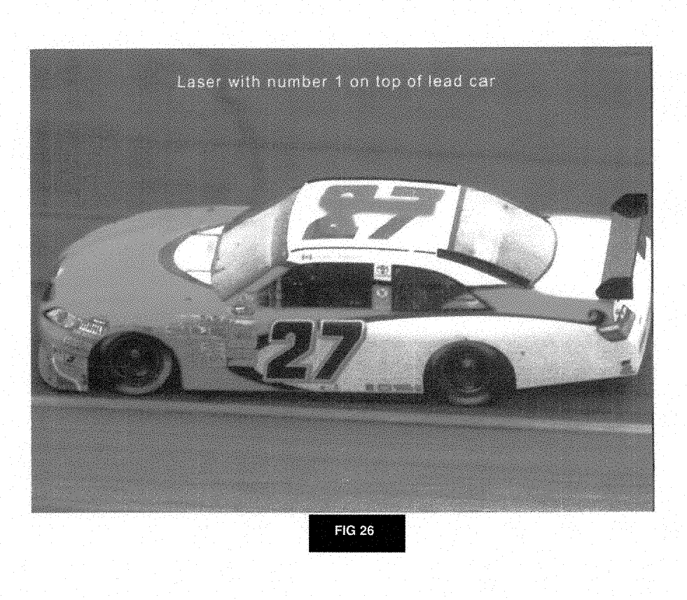

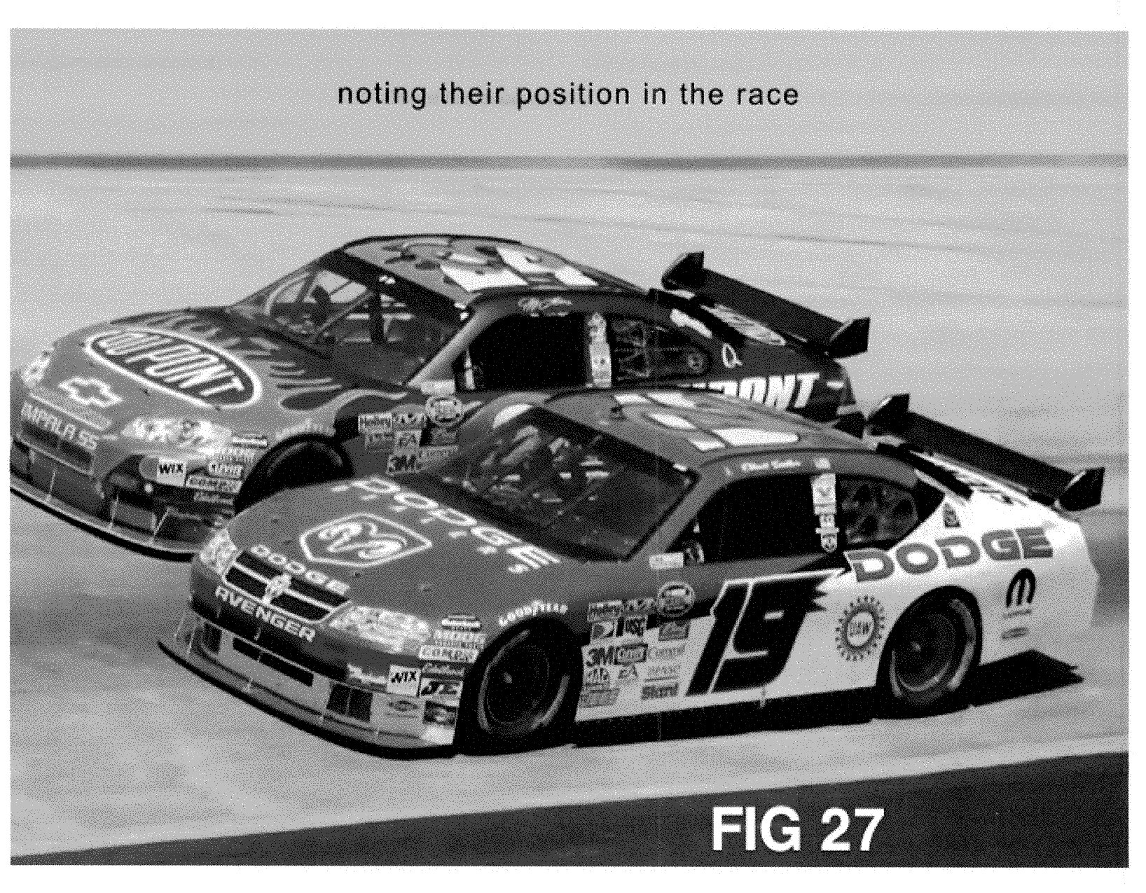

In a further embodiment, a system adapted for use in associate with objects movable on a target surface in a cyclical fashion (e.g. cars or runners racing in laps around a track) comprises a camera and algorithm determining the information of a still or moving object (not limited to) then based on calculation's sent to a laser projecting apparatus that is selectively movable along a field and or stadium and dimensioned and arranged to project at least one temporary, visible reference graphic onto a surface. Such as system is depicted in FIGS. 21-27, where FIG. 21 is an example of graphics projected on many objects according to an embodiment of the displaying a graphic on the tops of all objects on the filed stadium and or track; FIG. 22 is an example of system according to an embodiment of the invention projecting on the tops of each object car to display position in the race; FIG. 23 is an example of system according to an embodiment of the invention projecting on the tops of each object car to display position in the race; FIG. 24 is an example of a location for a laser source controlled by our program and projector system according to an embodiment of the invention; FIG. 25 is an overhead view of a predetermined preset graphic projected on to the objects (cars) to explain position numbers in the race for each car at that particular moment in the race for fans and everyone in the stadium to visible see. camera monitors and anticipates directional movements of the cars (objects, things and or people) frame by frame; FIG. 26 is an example car in position 1 winning the race, movements off the laser graphic based on predetermined programmed learned amount of laps accomplished without fouls, number of pit stops made etc; and FIG. 27 is an example cars in position 3 and 4 in the race, movements off the laser graphic based on predetermined programmed learned amount of laps accomplished without fouls, number of pit stops made etc

A camera and learning programmed system constructed in accordance with the embodiments of FIGS. 21-27 comprises a movable structure that is dimensioned and arranged to be supported by and project onto a target surface. The system further includes a laser projected source (not limited to) supported by the movable structure, the laser source being maintained by the movable structure (or mounted in one or more different locations) at an elevated location relative to the target surface. This allows the camera's view and laser projected source to direct optical energy (not limited to) downward upon the field or stadium while the movable structure (or still mounted) is maintained substantially in a first orientation relative to the target surface. The learning algorithm anticipates the movements of objects and things on the field in the stadium or on a track, to determine their location and amount of revolutions and or trips around the track in relation to the laser graphic, (not United to) to display a specific corresponding graphic determined. Non limiting examples of graphics which may be determined and projected include the number of revolutions, elapsed time from beginning the race, and/or a difference in pace between a given athlete and a leading athlete or applicable record (e.g., world record, event record, etc).

In an embodiment, a system according to FIGS. 21-27 comprises a camera structure that is dimensioned and arranged to be supported by and then aimed at target surfaces and track information required to determine position in the race at any given time. A computer program algorithm source is supported by the camera structure and is maintained by a movable or still mounted structure at an elevated location relative to the target surface. A system comprises of a camera structure that is dimensioned and arranged to be supported by and focused on and to an target surface. A computer program source is supported by the camera structure and is maintained by the movable or still mounted structure at an elevated location relative to the target field, track or surface. This allows the camera source to directly upon the view of the field while the movable structure is maintained substantially in a first orientation relative to the field, track objects target surface. Right now people at home (on TV graphics) can see little flags that lock on and track the tops of the cars for them to know the pol position throughout the race. But in the stadium no one has a clue as to who is actually in 1st, 2nd, 4th 9th position at any given time in the race. They have pit stops and unless you count the number of completed laps (which our algorithm dose automatically for all the cars on the field) no way to know who's winning. Enhanced In-stadium fan experience, give the fan paying the big dollars to watch live more bang for their paid in buck. Car #7 is in first place at the start of the race, so we have our laser projection system locked in and tracking the top of that car around the track with the clearly emblazon on the top of his/her car as it races around the track for everyone in the stadium and on TV at home to see what position he or she is in the race. Each car has their position in the race number emblazon on the top of the car. It changes instantly automatically (by our locked in tracking algorithm) as soon as the positions in the race change.

In yet a further embodiment consistent with the present disclosure, a helmet head directional camera and learning programmed system comprises a movable structure that is dimensioned and arranged to be supported by and project onto an athletic field surface. A camera and an algorithm executable by a processor of a computer which performs image analysis to determine helmet orientation and/or an algorithm executable by the processor of a computer to determine helmet orientation by analyzing accelerometer or other sensory input mounted on the helmet, controls switching on or off a laser projecting apparatus that is selectively movable along a first sideline of an athletic field and dimensioned and arranged to project at least one temporary, visible reference line across the athletic field surface. The system further includes a laser projected source supported by the movable structure, the laser source being maintained by the movable structure at an elevated location relative to the athletic field surface. This allows the camera's view and laser projected source to direct optical energy downward upon the field while the movable structure is maintained substantially in a first orientation relative to the athletic field surface. The learning algorithum anticipates the helmet and head directional movements of players and officials on the field of play, to determine their location in relation to the laser line, to shut off in case of caution preset zone and preset frames are determined.

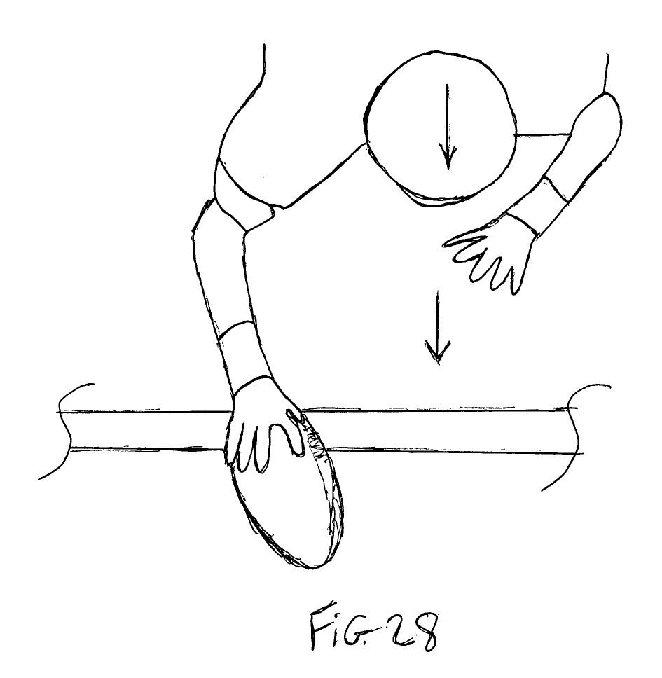

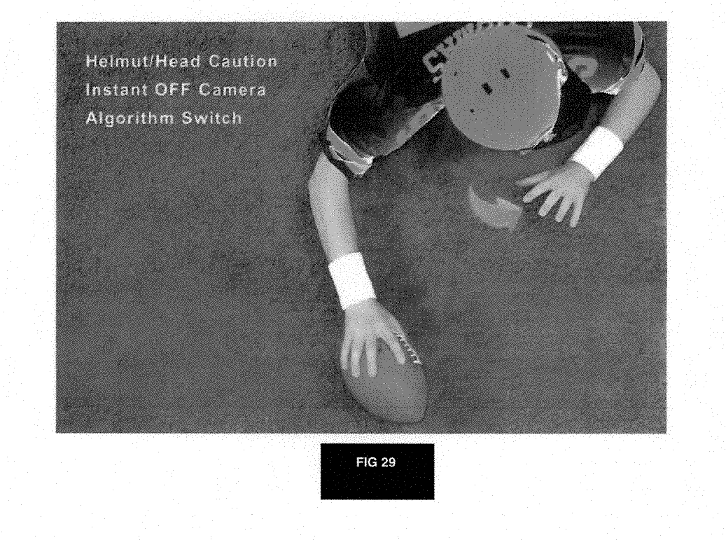

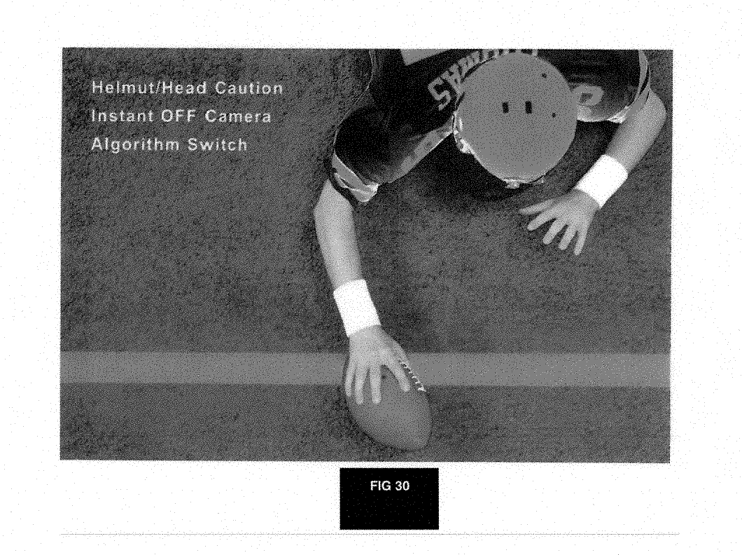

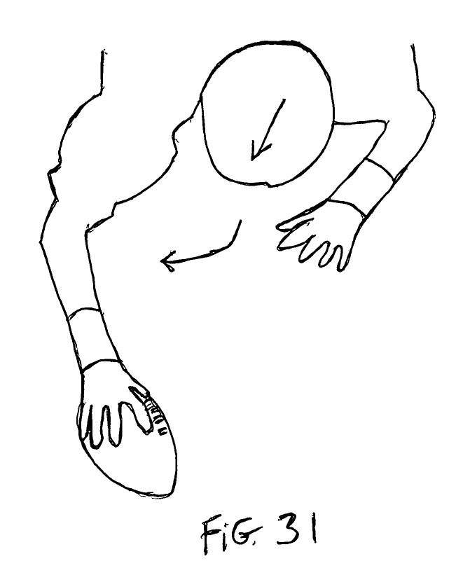

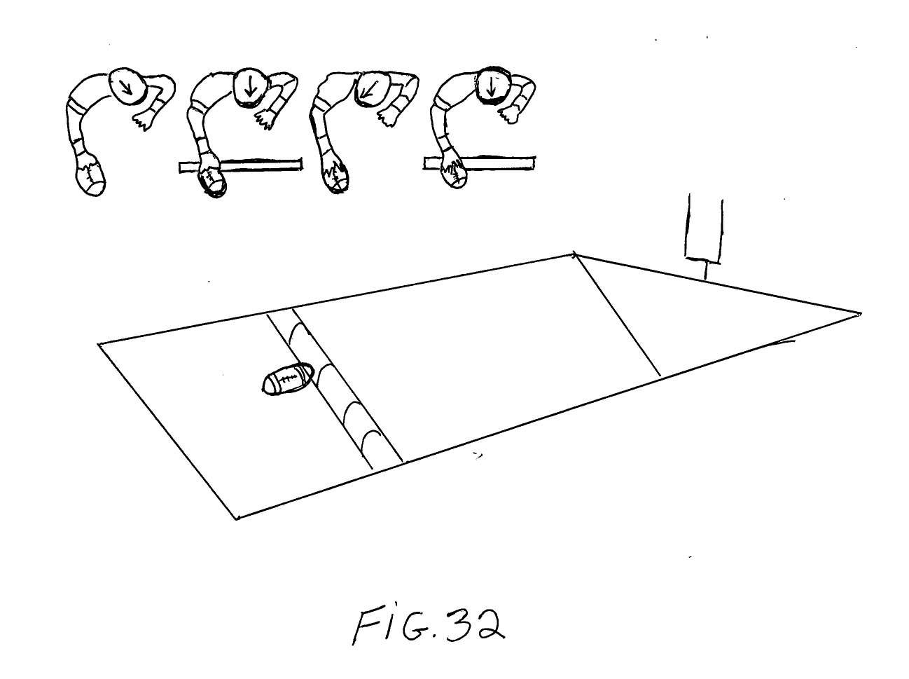

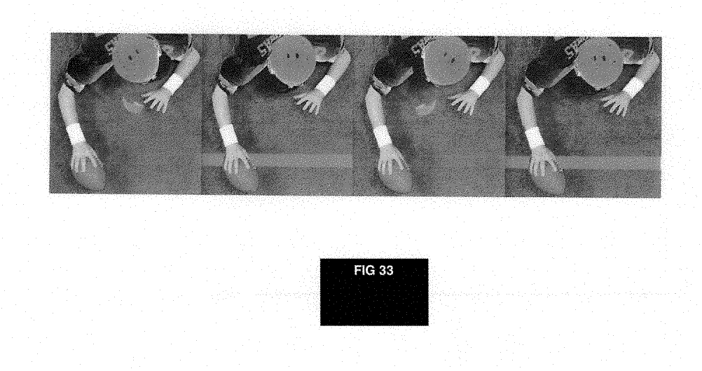

FIG. 28-33 depicts various orientations of a helmet as may be used to determine the orientation and position of the helmet relative to a line. Using orientation information, whether gathered by image analysis or sensors mounted on the helmet, the operation of an laser projection source can be interrupted as necessary to ensure safety. FIG. 28 is an example of camera frames and looking striaght positions system according to an embodiment for switching on or off a line projected on the ground. FIG. 29 is an example of frames and looking right positions system according to an embodiment of the invention switching the line on ground off. FIG. 30 is an example of frames and looking striaght positions system according to an embodiment of the invention switching the line on ground on. FIG. 31 is an example of frames and looking left positions system according to an embodiment of the invention shutting the line on ground off. FIG. 32 is an overhead view of a predetermined preset caution zone that the camera monitors and anticipates directional movements of the helmets and heads frame by frame. FIG. 33 is an example of frames of helmet and head movements to turn on and off the laser line based on predetermined programmed learned safety angles.

The slightest of Head Movement controls the line but only activated when player is in the caution zone and in the caution frames.
Helmet/Head Directional OFF Camera Switch
   Straight—line on
   Start turning left—line off
   Straight—line on
   Start turning right—line off
Helmet/Head Directional Movement Camera Algorithm Switch
120 frames per second camera (normal video is 30 frames per second) monitoring all players Helmet/head when in the 36″ inches high by 36″ inches wide by 53.3 yards across the field caution ZONE, will instantly shut OFF the laser line during frames 40 (which is the starting motion to turning and looking in the direction of the projector, and 120 which is looking directly towards the projector) and put the line back ON when clear of the caution ZONE or out of the caution FRAMES.
Two Criteria for the caution camera to activate
1-In ZONE
2-In FRAMES
Helmet/head in laser line caution ZONE (36″×36″×53.3 yards across) if players start to or are looking towards the projector laser line is instantly OFF (120 frames per second—at FRAME 40 to 120 frames the line is off, from frame 1 to frame 39 the line is ON)
Line ON during FRAMES 1 to 39 (and when out of ZONE) as example only
Line OFF during FRAMES 40 to 120 as example only
By projecting a laser line over another laser line (each other) from both sides of the field, one line may be on while the other line may be off Always showing a line to beat.
If another player is blocking the beam and camera (both beam and camera may be coming from the same place) that means the player on the ground is also blocked from the beam if blocked from the camera.

While given components of the system have been described separately, one of ordinary skill also will appreciate that some of the functions may be combined or shared in given instructions, program sequences, code portions, and the like. The invention being thus described, it will be obvious that the same may be varied in many ways. Such variations are not to be regarded as a departure from the spirit and scope of the invention, and all such modifications as would be obvious to one skilled in the art are to be included within the scope of the following claims.

In FIGS. 1-40 shown attached here are examples of preferred suggested embodiments in sports and industry uses for a temporary or permanent safe line projection system comprises a stationary or movable structure that is dimensioned and arranged to be supported by and project upwardly from an athletic field surface (or other surfaces needing delineation). A laser source is supported by the movable or stationary structure and is maintained by the movable or stationary structure at an elevated location relative to the athletic field surface (or other surface requiring delineation). This allows the laser source to direct safe optical energy downward upon the field while the movable or stationary structure is maintained substantially in a first orientation relative to the athletic field surface (or other surfaces desiring delineation). A sensing arrangement is operative to to disable the laser source or modulate its output depending upon proximity of users to the system or its output and upon ambient lighting conditions, as the case may be.

All the attached examples of suggested preferred embodiments (but not limited to these named) and uses in FIGS. 1-40 must conform to all the rules and regulations set by the governing branch of the FDA called the CDRH. This patent filing adheres to those rules and regulations by a new safe projection of strong laser sources mounted and disseminated different angled and located beam(s) to keep the intense brightness but eliminate all danger. None of the previous patent filings and or prior art has come close to these new safety regulations, and this patent filing makes these systems safe for actual use.

1. An apparatus for providing a temporary safe visible reference mark upon a surface despite dynamically variable ambient lighting conditions, comprising:
a laser source positionable at an elevated location relative to the surface and operative to direct optical energy at a wavelength of between 380 nm and 750 nm upon the surface;
an ambient light sensor dimensioned and arranged to detect variations in an intensity of sunlight in a zone proximate the surface so as to approximate an intensity of sunlight striking the surface;
a laser source modulating system operatively associated with said ambient light sensor and operative to one of reduce and disable an output of said laser source when a level of ambient light intensity detected by said ambient light sensor falls below a selectable threshold.

2. The apparatus according to claim 1, wherein said laser source modulating system is further operative to increase an output of said laser source when a level of ambient light intensity detected by said ambient light sensor exceeds a selectable threshold.

3. The apparatus according to claim 1, wherein said laser source modulating system is responsive to an output of the ambient light intensity sensor to dynamically vary an amount of optical energy delivered to the surface as necessary to remain in compliance with one of a Class 1 and Class IIIa mode of operation.

4. The apparatus according to claim 1, wherein said laser source includes a movable projector head and at least one laser remotely located from and optically coupled to said movable projector head assembly.

5. The apparatus according to claim 4, wherein said laser has a power rating of between 10 W and 100 W, the laser source further including a cooling system for maintaining the laser at a safe operating temperature during use.

6. The apparatus according to claim 1, wherein the laser source includes a single laser disposed within a housing secured to a movable, trailer-mounted structure.

7. The apparatus according to claim 6, wherein the laser source is rated at from 5 to 10 W.

8. The apparatus according to claim 1, further including a position measuring system adapted to sense an impending entry of a rapidly approaching person into optical energy emitted by the laser source, said safety switch being responsive to the position measuring system to disable to the laser source before such entry occurs.

9. A method of operating a laser projecting system during dynamically variable ambient lighting conditions, comprising:
positioning a laser source at an elevated location relative to a surface and directing optical energy at a wavelength of between 380 nm and 750 nm upon the surface to thereby project a temporary marker thereon;
one of reducing and disabling an output of the laser source when a level of ambient light intensity detected by said ambient light sensor falls below a selectable threshold.

10. The method according to claim 9, further including a step of projecting a plurality of markers simultaneously during a single athletic event.

11. The method according to claim 10, wherein the athletic event is a track and field event and wherein the markers correspond to at least one of a distance measurement achieved by a currently competing athlete during the present event, a distance measurement achieved by an athlete leading in the present event, and a distance measurement achieved by a world record holder of the present event.

12. The method according to claim 9, further including a step of projecting a reference line during a football game.

13. The method according to claim 9, wherein the energy directed at the surface has a wavelength of between 514 and 570 nm.

14. The method according to claim 9, further including a step of increasing an output of the laser source when a level of ambient light intensity exceeds a selectable threshold.

15. The method according to claim 9, further comprising a step of dynamically varying an amount of optical energy delivered to the surface as necessary to maintain the laser source in a Class 1 mode of operation.

16. A temporary or permanent safe line projection system comprises a stationary or movable structure that is dimensioned and arranged to be supported by and project upwardly from an athletic field surface (or other surfaces needing delineation). A laser source is supported by the movable or stationary structure and is maintained by the movable or stationary structure at an elevated location relative to the athletic field surface (or other surface needing delineation). This allows the laser source to direct safe optical energy downward upon the field while the movable or stationary structure is maintained substantially in a first orientation relative to the athletic field surface (or other surfaces desiring delineation). A sensing arrangement is operative to to disable the laser source or modulate its output depending upon proximity of users to the system or its output and upon ambient lighting conditions, as the case may be.

17. A system and method that conforms to all the rules and regulations set by the governing branch of the FDA called the CDRH. This patent filing adheres to those rules and regulations by a new safe projection of strong laser sources mounted and disseminated different angled and located beam(s) to keep the intense brightness but eliminate all danger. None of the previous patent filings and or prior art has come close to these new safety regulations, and this patent filing now makes these systems safe for actual use.
